(19) United States
(12) Patent Application Publication
(10) Pub. No.: US 2013/0336281 A1
(43) Pub. Date: Dec. 19, 2013

(54) APPARATUS AND METHOD FOR COORDINATING IN-DEVICE COEXISTENCE INTERFERENCE IN A WIRELESS COMMUNICATION SYSTEM

(71) Applicants: Jae Hyun Ahn, Seoul (KR); Ki Bum Kwon, Seoul (KR); Myung Cheul Jung, Seoul (KR)

(72) Inventors: Jae Hyun Ahn, Seoul (KR); Ki Bum Kwon, Seoul (KR); Myung Cheul Jung, Seoul (KR)

(73) Assignee: Pantech Co., Ltd., Seoul (KR)

(21) Appl. No.: 13/979,606

(22) PCT Filed: Jan. 12, 2012
(86) PCT No.: PCT/KR2012/000294

§ 371 Date: Aug. 29, 2013

(30) Foreign Application Priority Data
Jan. 12, 2011 (KR) 10-2011-003247
Oct. 27, 2011 (KR) 10-2011-0110799

(51) Int. Cl. H04W 72/08

(52) U.S. Cl. CPC H04W 72/082
USPC 370/330

(57) ABSTRACT

This specification provides an apparatus and method for coordinating IDC interference in a wireless communication system. The method includes performing triggering for requesting an eNB to coordinate interference generated in reception in a second frequency band of a second network system within UE due to transmission in a first frequency band of a first network system within the UE, sending HAI, comprising first assistance information that supports the eNB in coordinating the interference in a frequency domain based on an FDM scheme and second assistance information that supports the eNB in coordinating the interference in a time domain based on a TDM scheme, to the eNB, and receiving response information indicative of an acceptance or rejection of the coordination of the interference from the eNB as a response to the HAI.

### CROSS-REFERENCE TO RELATED APPLICATIONS

This application is the National Stage Entry of International Application PCT/KR2012/000294, filed on Jan. 12, 2012, and claims priority from and the benefit of Korean Patent Application No. 10-2011-0003247, filed on Jan. 12, 2011, and Korean Patent Application No. 10-2011-0110799, filed on Oct. 27, 2011, which are incorporated herein by reference for all purposes as if fully set forth herein.

### BACKGROUND

1. Field

The present invention relates to wireless communication and, more particularly, to an apparatus and method for coordinating In-Device Coexistence (IDC) interference in a wireless communication system.

2. Discussion of the Background

In general, a wireless communication system uses one bandwidth for data transmission. For example, the 2^{nd} generation wireless communication system uses a bandwidth of 200 KHz to 1.25 MHz, and the 3^{rd} generation wireless communication system uses a bandwidth of 5 MHz to 10 MHz. In order to support an increasing transmission capacity, the bandwidth of the recent 3^{rd} Generation Partnership Project (3GPP) Long Term Evolution (LTE) or Institute of Electrical and Electronics Engineers (IEEE) 802.16m continues to extend up to 20 MHz or higher. To increase the bandwidth so as to increase the transmission capacity can be considered to be indispensable, but to support a great bandwidth even when necessary quality of service is low may result in great power consumption.

Therefore, there is emerging a multiple component carrier system in which a carrier having one bandwidth and a center frequency is defined and data can be transmitted or received through a plurality of carriers using a wide band. A multiple component carrier system supports both a narrow band and a wide band by using one or more carriers. For example, if one carrier corresponds to a bandwidth of 5 MHz, a maximum of a 20 MHz bandwidth is supported by using four carriers.

Users at different areas can access different networks with the help of recent ubiquitous access networks and continue to maintain the access thereto. A user who performs communication with one network system through one terminal carries different devices that support respective network systems. As the function of a recent single terminal is advanced and complicated, a user can simultaneously perform communication with a plurality of network systems using only one terminal, thereby increasing user convenience.

If one terminal performs communication in a plurality of network system bands simultaneously, IDC interference can be generated. IDC interference means interference in which transmission in one frequency band interferes with reception in the other frequency band within the same terminal. For example, if a terminal simultaneously supports a Bluetooth system and an LTE system, IDC interference can be generated between a Bluetooth system band and an LTE system band. IDC interference can be commonly generated when an interval between the frequency band boundaries of different network systems is not sufficiently wide.

In a current wireless communication system, however, a detailed scheme for coordinating IDC interference has not yet been determined. In other words, there is a need for an operational procedure for a detailed operation for solving IDC interference between a terminal and a base station because the detailed operation has not yet been discussed.

### SUMMARY

An object of the present invention is to provide an apparatus and method for coordinating IDC interference.

Another object of the present invention is to provide an apparatus and method for coordinating IDC interference based on a mixed method in which a Frequency Division Multiplexing (FDM) scheme and a Time Division Multiplexing (TDM) scheme are mixed.

Yet another object of the present invention is to provide an apparatus and method for transmitting Hybrid Assistance Information (HAI) that supports the coordination of IDC interference in a wireless communication system.

Further yet another object of the present invention is to provide an apparatus and method for determining a method of coordinating IDC interference based on a mixed method.

In accordance with an aspect of the present invention, there is provided a method of UE coordinating interference in a wireless communication system. The method includes performing triggering for requesting an eNB to coordinate interference generated in reception in a second frequency band of a second network system within the UE due to transmission in a first frequency band of a first network system within the UE, sending HAI, including first assistance information that supports the eNB in coordinating the interference in a frequency domain based on an FDM scheme and second assistance information that supports the eNB in coordinating the interference in a time domain based on a TDM scheme, to the eNB, and receiving response information indicative of the acceptance or rejection of the coordination of the interference from the eNB as a response to the HAI.

In accordance with another aspect of the present invention, there is provided UE for coordinating interference in a wireless communication system. The UE includes an interference coordination request triggering unit for performing triggering for requesting an eNB to coordinate interference generated in reception in a second frequency band of a second network system within the UE due to transmission in a first frequency band of a first network system within the UE, an HAI generation unit for generating HAI, including first assistance information that supports a coordination of the interference in a frequency domain based on an FDM scheme and second assistance information that supports the coordination of the interference in a time domain based on a TDM scheme, an HAI transmission unit for sending the HAI, and a response information reception unit for receiving response information indicative of the acceptance or rejection of the coordination of the interference from the eNB as a response to the HAI.

In accordance with yet another aspect of the present invention, there is provided a method of an eNB performing interference coordination in a wireless communication system. The method includes receiving HAI, supporting a coordination of interference in a frequency domain based on an FDM scheme or supporting the coordination of the interference in a time domain based on a TDM scheme, from UE, assessing a better scheme of the FDM scheme and the TDM scheme which is more suitable for coordinating the interference, sending response information, indicating that the coordination of the interference is performed according to a scheme selected based on the assessment or that the coordination of the interference is rejected if both the FDM scheme and the TDM scheme are not suitable for coordinating the interference based on the assessment, to the UE, wherein the interference is generated in reception in a second frequency band of a second network system within the UE due to transmission in a first frequency band of a first network system within the UE.

In accordance with further yet another aspect of the present invention, there is provided an eNB for performing interference coordination in a wireless communication system. The eNB includes an HAI reception unit for receiving HAI, supporting a coordination of interference in a frequency domain based on an FDM scheme or supporting the coordination of the interference in a time domain based on a TDM scheme, from UE, an interference coordination execution unit for assessing a better scheme of the FDM scheme and the TDM scheme which is more suitable for coordinating the interference and performing the coordination of the interference according to any one of the FDM scheme and the TDM scheme selected based on the assessment, a response information transmission unit for sending response information, indicating that the coordination of the interference is performed according to a scheme selected based on the assessment or that the coordination of the interference is rejected if both the FDM scheme and the TDM scheme are not suitable for coordinating the interference based on the assessment, to the UE, wherein the interference is generated in reception in a second frequency band of a second network system within the UE due to transmission in a first frequency band of a first network system within the UE.

In accordance with the present invention, a procedure for processing IDC interference can be simplified, an implementation is facilitated, and backward compatibility with other procedures can be maintained. Furthermore, pieces of information about IDC interference exchanged between UE and an eNB can be clearly defined, and IDC interference can be solved efficiently.

### BRIEF DESCRIPTION OF THE DRAWINGS

FIG. 1 shows a wireless communication system to which embodiments of the present invention are applied;

FIG. 2 is an explanatory diagram illustrating IDC interference;

FIG. 3 shows an example of IDC interference from an ISM transmitter to an LTE receiver;

FIG. 4 shows an example in which an ISM band is separated from an LTE band on a frequency band;

FIG. 5 is an explanatory diagram illustrating an example in which IDC interference is reduced using an FDM scheme;

FIG. 6 is an explanatory diagram illustrating another example in which IDC interference is reduced using the FDM scheme;

FIG. 7 is an explanatory diagram illustrating an example in which IDC interference is reduced using a TDM scheme;

FIG. 8 shows transmission and reception timing on the time axis of an LTE band and an ISM band using the TDM scheme;

FIG. 9 is a flowchart illustrating a method of coordinating IDC interference based on a mixed method in accordance with an example of the present invention;

FIG. 10 is a diagram illustrating second assistance information in accordance with an example of the present invention;

FIG. 11 is a diagram illustrating second assistance information in accordance with another example of the present invention;

FIG. 12 is a diagram illustrating second assistance information in accordance with yet another example of the present invention;

FIG. 13 is a flowchart illustrating a method of UE performing interference coordination in accordance with an example of the present invention;

FIG. 14 is a flowchart illustrating a method of UE performing interference coordination in accordance with another example of the present invention;

FIG. 15 is a flowchart illustrating a method of an eNB performing interference coordination in accordance with an example of the present invention;

FIGS. 16 to 18 are diagrams illustrating a method of coordinating IDC interference by way of a frequency shift or shaping in accordance with an example of the present invention;

FIG. 19 is a diagram illustrating the operation of UE in DRX mode when response information is a DRX command message in accordance with an example of the present invention;

FIG. 20 is a flowchart illustrating a method of an eNB performing interference coordination in accordance with another example of the present invention; and

FIG. 21 is a block diagram of an apparatus for coordinating IDC interference in accordance with an example of the present invention.

### DETAILED DESCRIPTION OF THE ILLUSTRATED EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in describing the elements of this specification, terms, such as the first, the second, A, B, (a), and (b), may be used. However, although the terms are used only to distinguish one element from the other element, the essence, order, or sequence of the elements is not limited by the terms. When it is said that one element is ‘connected’, ‘combined’, or ‘coupled’ with the other element, the one element may be directly connected or coupled with the other element, but it should also be understood that a third element may be ‘connected’, ‘combined’, or ‘coupled’ between the two elements.

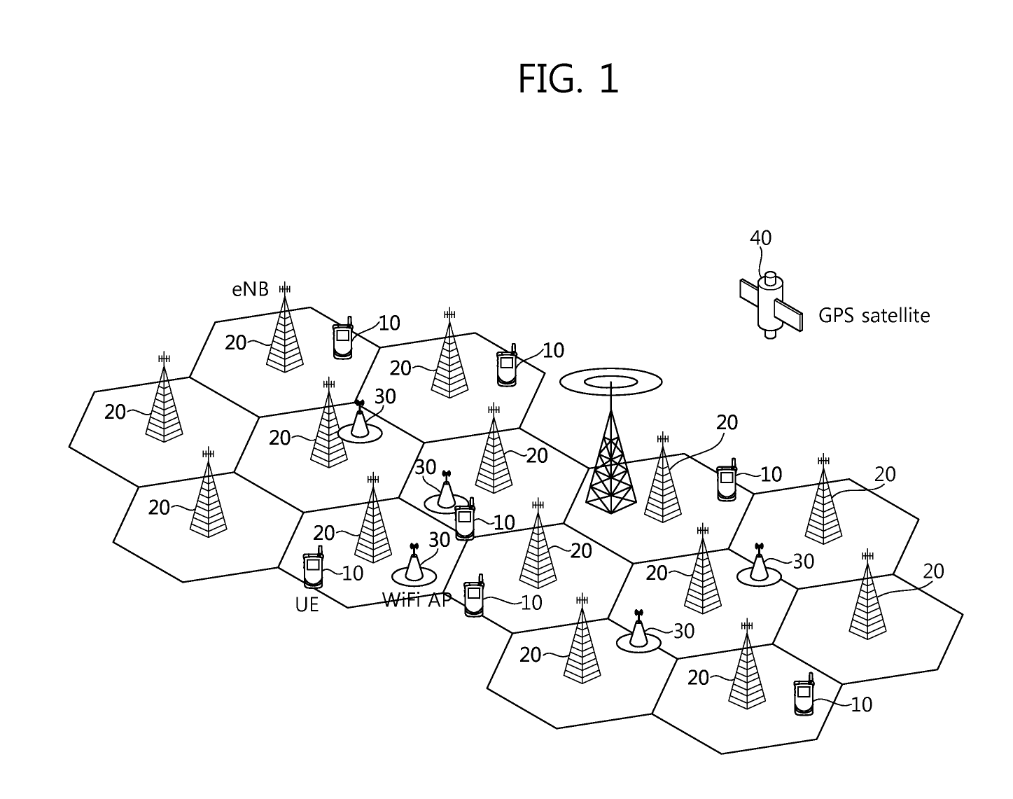

FIG. 1 shows a wireless communication system to which embodiments of the present invention are applied.

Referring to FIG. 1, a plurality of mobile communication systems is widely deployed in order to provide various communication services, such as voice and packet data. The mobile communication system includes User Equipments (UEs) 10, evolved NodeBs (eNBs) 20, a Wireless LAN (WLAN) Access Points (APs) 30, and a Global Positioning System (40) satellite. Here, the WLAN is an apparatus that supports IEEE 802.11 technology, that is, a wireless standard, and an IEEE 802.11 system can be mixed with a WiFi system in its name.

The UE 10 can be placed in the coverages of a plurality of networks, such as a cellular network, a WLAN, a broadcasting network, and a satellite system. The UE 10 is equipped with a plurality of radio transceivers in order to access a variety of networks, such as the eNB 20, the WLAN access point 30, and the GPS 40, and services anywhere, at any time. For example, a smart phone is equipped with LTE, WiFi, and Bluetooth transceivers and a GPS receiver. In order to integrate many transceivers within one UE 10 while maintaining better performance as described above, the design of the UE 10 becomes more complicated. As a result, there is a strong possibility that IDC interference may occur.

Hereinafter, downlink (DL) refers to communication from the eNB 20 to the UE 10, and uplink (UL) refers to communication from the UE 10 to the eNB 20. In downlink, a transmitter can be part of the eNB 20 and a receiver can be part of the UE 10. Furthermore, in UL, a transmitter can be part of the UE 10 and a receiver can be part of the eNB 20.

The UE 10 can be fixed or mobile and can also be called another term, such as a Mobile Station (MS), a User Terminal (UT), a Subscriber Station (SS), a Mobile Station (MT), or a wireless device. The eNB 20 refers to a fixed station communicating with the UE 10, and the eNB 20 can also be called another term, such as a Base Station (BS), a Base Transceiver System (BTS), an access point, a femto BS, or a relay.

Multiple access schemes applied to the wireless communication system are not limited. Various types of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier-FDMA (SC-FDMA), OFDM-FDMA, OFDM-TDMA, and OFDM-CDMA, can be used. Uplink transmission and downlink transmission can be performed in accordance with a Time Division Duplex (TDD) method using different times or a Frequency Division Duplex (FDD) method using different frequencies.

Meanwhile, a Carrier Aggregation (CA) supports a plurality of carriers, and the CA is also called a spectrum aggregation or a bandwidth aggregation. An individual unit carrier aggregated by a CA is called a Component Carrier (hereinafter referred to as a ‘CC’). Each CC is defined by a bandwidth and a center frequency. A CA is introduced in order to support an increased throughput, prevent an increase of costs due to the introduction of wideband Radio Frequency (RF) devices, and guarantee compatibility with the existing systems. For example, if 5 CCs are allocated as the granularity of a carrier unit having a 20 MHz bandwidth, a maximum of a 100 MHz bandwidth can be supported. Hereinafter, a multiple carrier system refers to a system supporting a CA. The wireless communication system of FIG. 1 can be a multiple carrier system.

In accordance with a CA, a system frequency band is divided into a plurality of carrier frequencies. The carrier frequency refers to the center frequency of a cell. The cell can mean a DL CC and a UL CC. Alternatively, the cell may mean a combination of a DL CC and an optional UL CC. Furthermore, if a CA is not taken into consideration, one cell always includes a pair of UL and DL CCs.

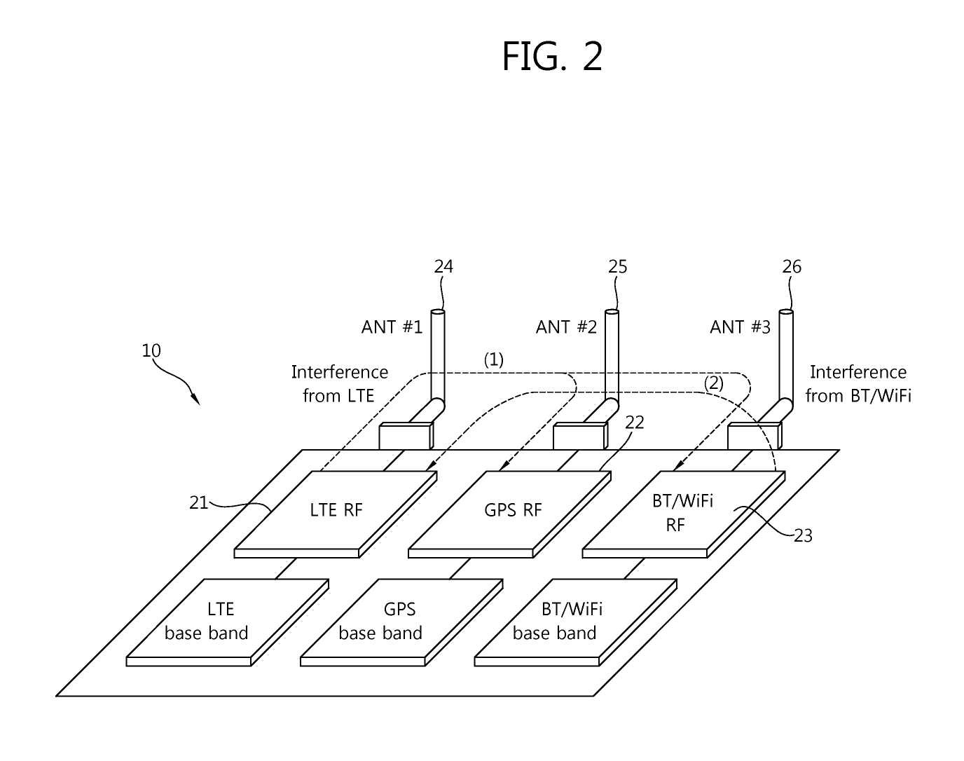

FIG. 2 is an explanatory diagram illustrating IDC interference.

Referring to FIG. 2, the UE 10 includes an LTE Radio Frequency (RF) 21, a GPS RF 22, and a BT/WiFi RF 23. Transmission and reception antennas 24, 25, and 26 are coupled with the respective LTE RF 21, GPS RF 22, and BT/WiFi RF 23. That is, various types of RFs are proximately disposed within one device platform. Here, a transmission power level of one RF toward the other RF receiver may be very greater than a reception power level of the other RF. In this case, if frequency spacing between the RFs is not sufficiently wide and an advanced filtering technique is not supported, the transmission signal of one RF may generate significant interference with the other RF receiver within the same device.

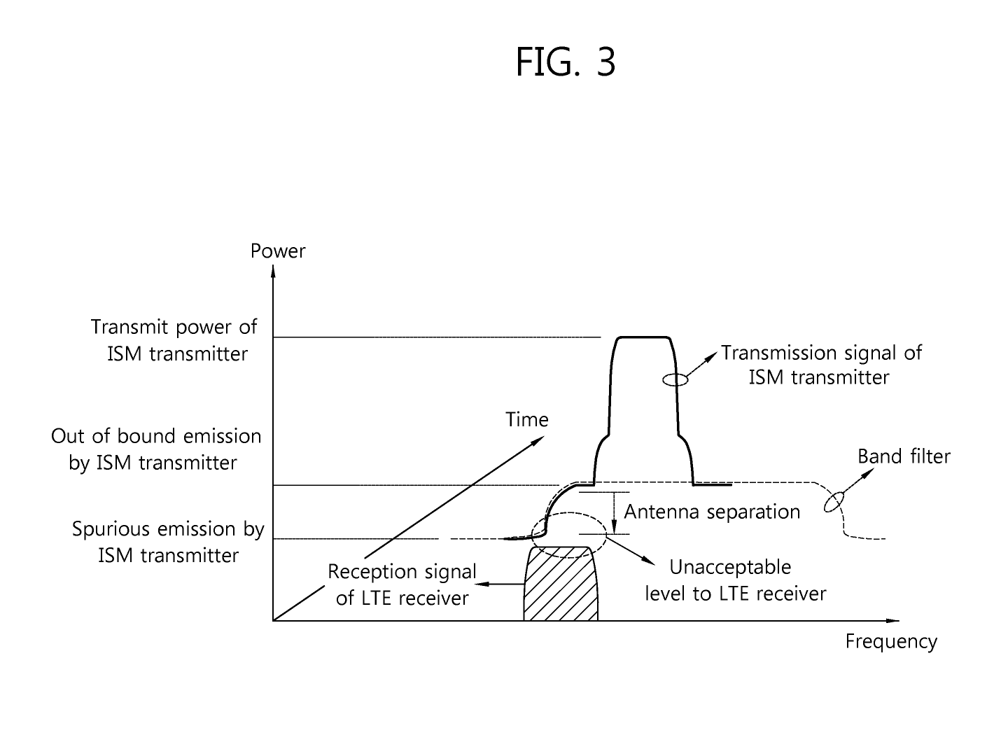

For example, (1) shows an example in which the transmission signal of the LTE RF 21 generates IDC interference with the GPS RF 22 and the BT/WiFi RF 23, and (2) shows an example in which the transmission signal of the BT/WiFi RF 23 generates IDC interference with the LTE RF 21. This problem is described in more detail with reference to FIG. 3.

FIG. 3 shows an example of IDC interference from an Industrial, Scientific and Medical (ISM) transmitter to an LTE receiver. An ISM band is a band which is freely used in the industrial, scientific, and medical fields without license.

From FIG. 3, it can be seen that the band of a signal received by the LTE receiver overlaps with the band of a signal transmitted by the ISM transmitter. In this case, IDC interference can occur.

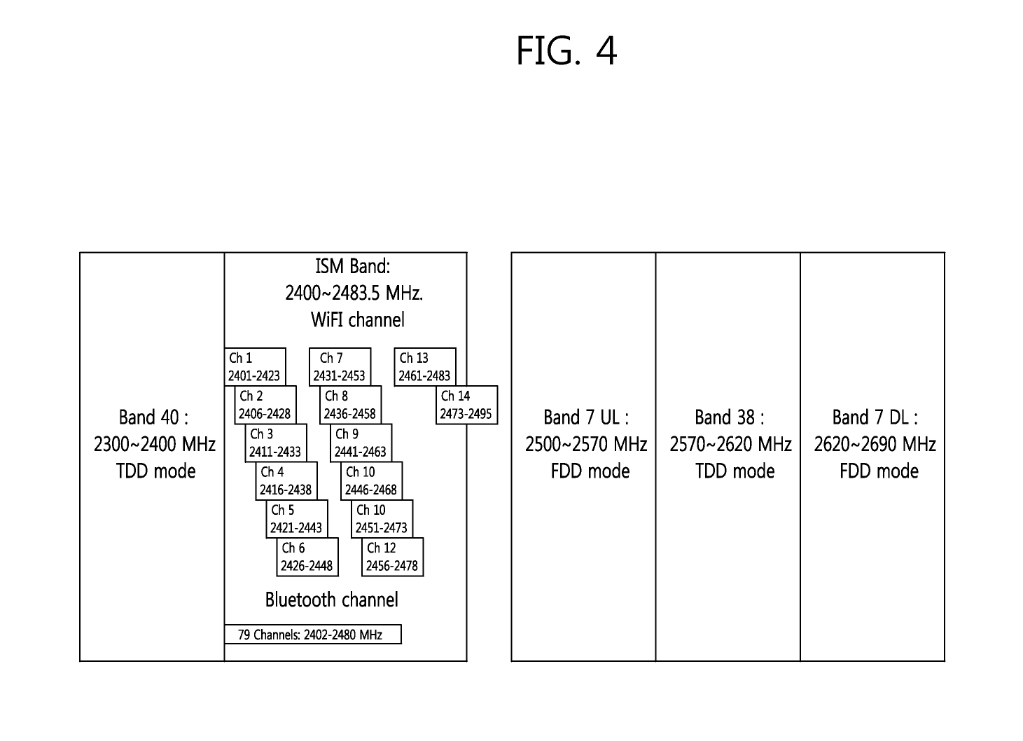

FIG. 4 shows an example in which an ISM band is separated from an LTE band on a frequency band.

Referring to FIG. 4, a band 40, a band 7, and a band 38 are LTE bands. The band 40 occupies a band of 2300 to 2400 MHz in TDD mode, and the band 7 occupies a band of 2500 to 2570 MHz in FDD mode in UL. Furthermore, the band 38 occupies a band of 2570 to 2620 MHz in TDD mode. Meanwhile, the ISM band is used as a WiFi channel and a Bluetooth channel, and it occupies a band of 2400 to 2483.5 MHz. Here, conditions in which IDC interference is generated are listed in the following.

TABLE 1

| INTERFERENCE BAND | TYPE OF INTERFERENCE |
|---|---|
| Band 40 | ISM Tx -> LTE TDD DL Rx |
| Band 40 | LTE TDD UL Tx -> ISM Rx |
| Band 7 | LTE FDD UL Tx -> ISM Rx |
| Bands 7/13/14 | LTE FDD UL Tx -> GPS Rx |

Referring to Table 1, in the type of interference, a mark ‘a->b’ indicates that the transmission (Tx) of ‘a’ generates IDC interference with the reception (Rx) of ‘b’. Accordingly, in the band 40, Tx in the ISM band generates IDC interference with LTE TDD DL Rx of the LTE band. IDC interference can be reduced to some extent using a filtering scheme, but this method is not sufficient. If the FDM scheme or the TDM scheme is additionally applied to the filtering scheme, IDC interference can be reduced further efficiently.

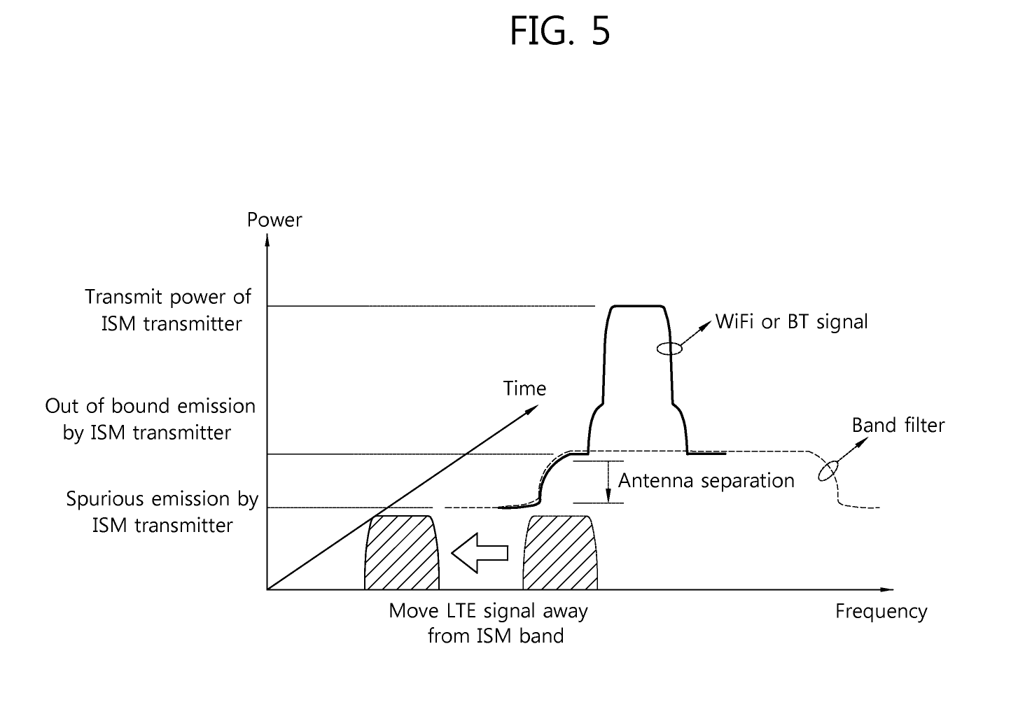

FIG. 5 is an explanatory diagram illustrating an example in which IDC interference is reduced using the FDM scheme.

Referring to FIG. 5, the LTE band can be moved so that the LTE band does not overlap with the ISM band. This leads to the handover of UE from the ISM band. To this end, there is a need for a method in which legacy measurement or new signaling precisely triggers a mobility procedure or a Radio Link Failure (RLF) procedure.

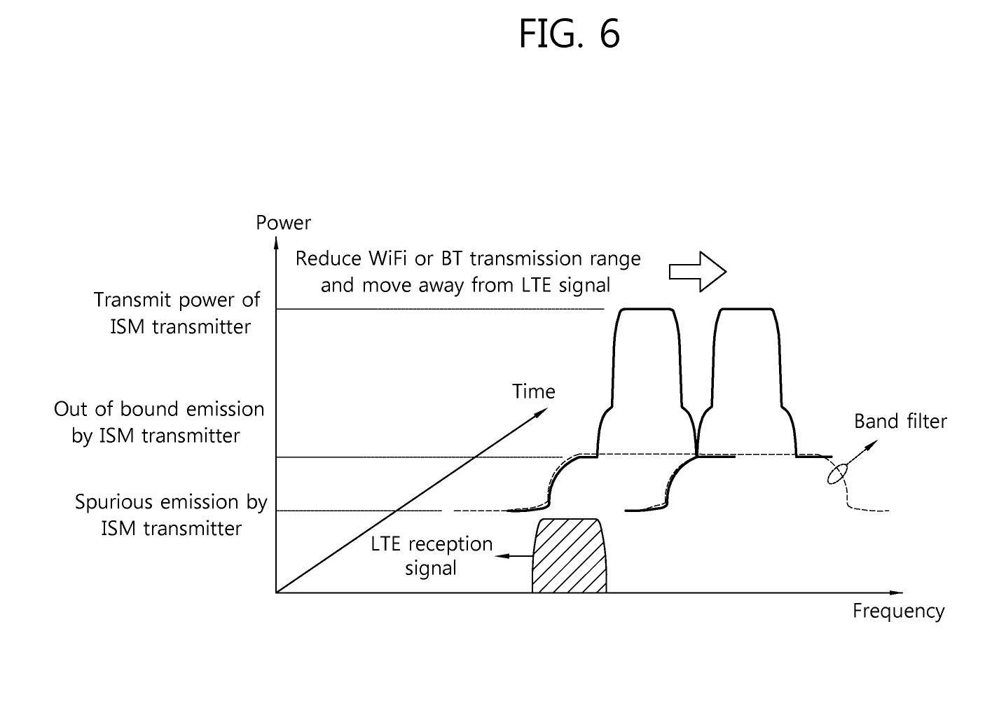

FIG. 6 is an explanatory diagram illustrating another example in which IDC interference is reduced using the FDM scheme.

Referring to FIG. 6, the ISM band can be reduced and can be moved so that it is separated from the LTE band. In this method, however, a backward compatibility problem can occur. In the case of Bluetooth, the backward compatibility problem can be solved to some extent by way of an adaptive frequency hopping mechanism. In the case of WiFi, however, it may be difficult to solve the backward compatibility problem.

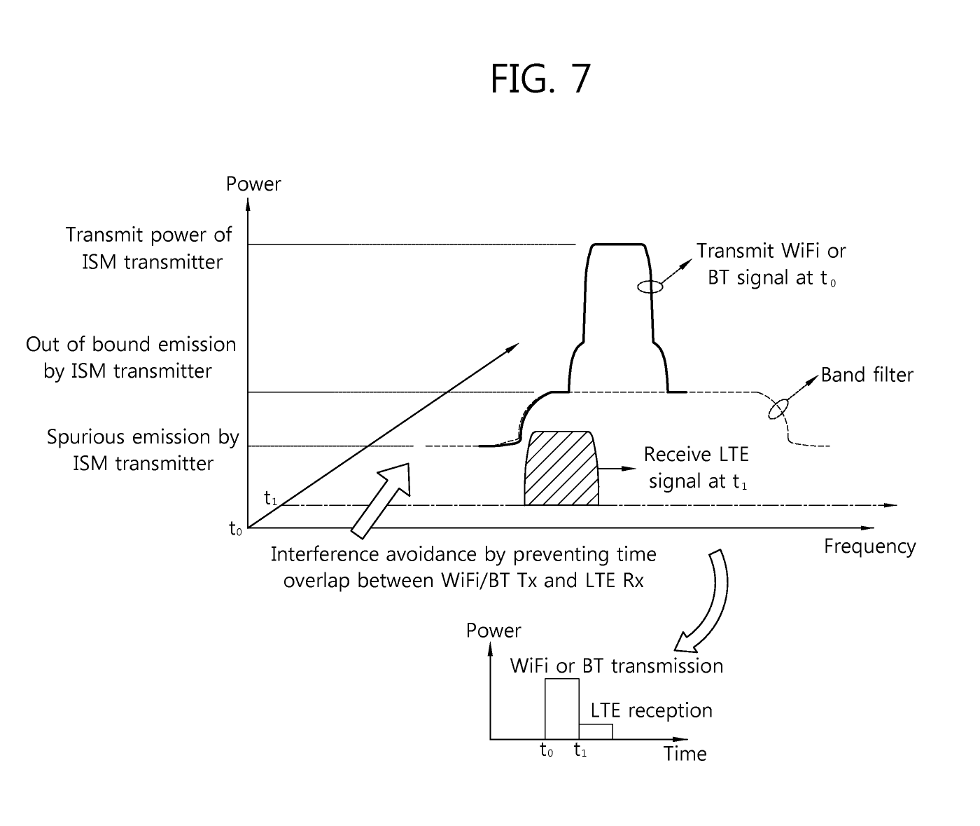

FIG. 7 is an explanatory diagram illustrating an example in which IDC interference is reduced using the TDM scheme.

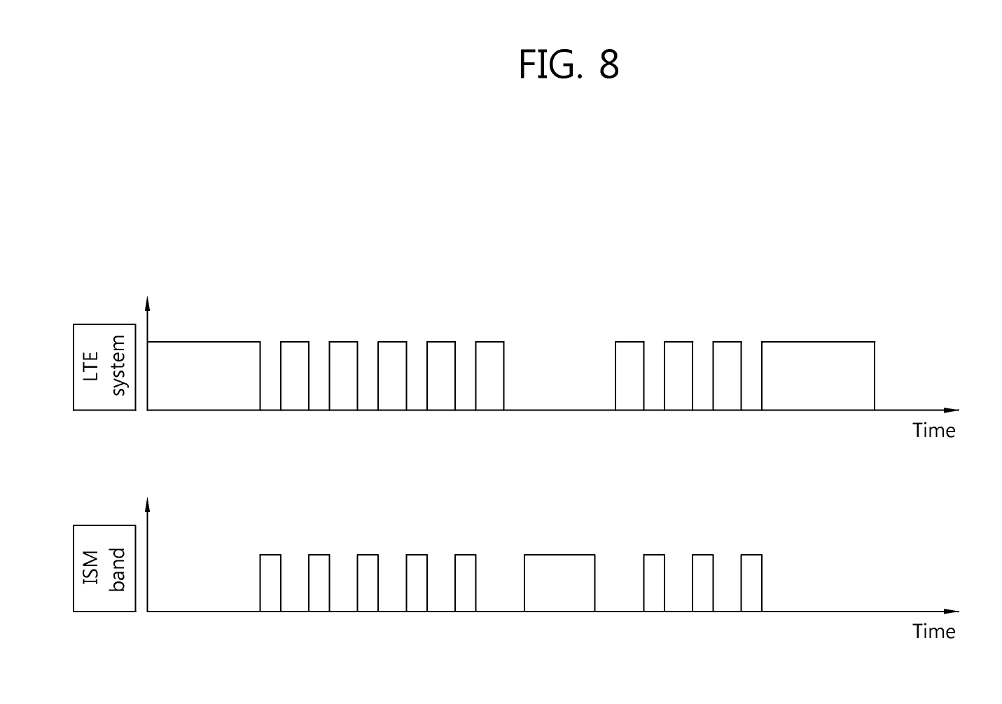

Referring to FIG. 7, if a reception time in the LTE band is made not overlap with a transmission time in the ISM band, IDC interference can be avoided. For example, if a signal having the ISM band is transmitted at t₀, a signal having the LTE band is received at t₁. Transmission and reception timing on the time axis of the LTE band and the ISM band using the TDM scheme as described above can be indicated as in FIG. 8. If this method is used, IDC interference can be avoided without a movement between the LTE band and the ISM band. In FIG. 8, an interval of each band in which a signal is not transmitted is called a blank transmission region.

As described above, the TDM scheme and the FDM scheme have unique characteristics. The TDM scheme can be applied to an environment in which only one carrier band has been configured in UE. In the TDM scheme, however, interference may become severe or communication may become almost impossible depending on the type of traffic used in UE because time resources are shared between network systems. In contrast, the FDM scheme cannot be applied to an environment in which only one carrier band has been configured in UE. However, the occurrence of interference in the FDM scheme is less sensitive than that in the TDM scheme depending on the type of traffic because a band in which interference is generated can be perfectly avoided. Interference can be coordinated more efficiently by properly supplementing the advantages and disadvantages of the TDM scheme and the FDM scheme and mixing the two schemes.

In relation to the present invention, the FDM scheme and the TDM scheme can be used as techniques for avoiding IDC interference. The FDM scheme is a scheme for coordinating IDC interference by moving the frequency band of any one network system when interference is generated between a first frequency band of a first network system and a second frequency band of a second network system. Meanwhile, the TDM scheme is a scheme for coordinating IDC interference by separating a transmission time of a first network system from a reception time of a second network system.

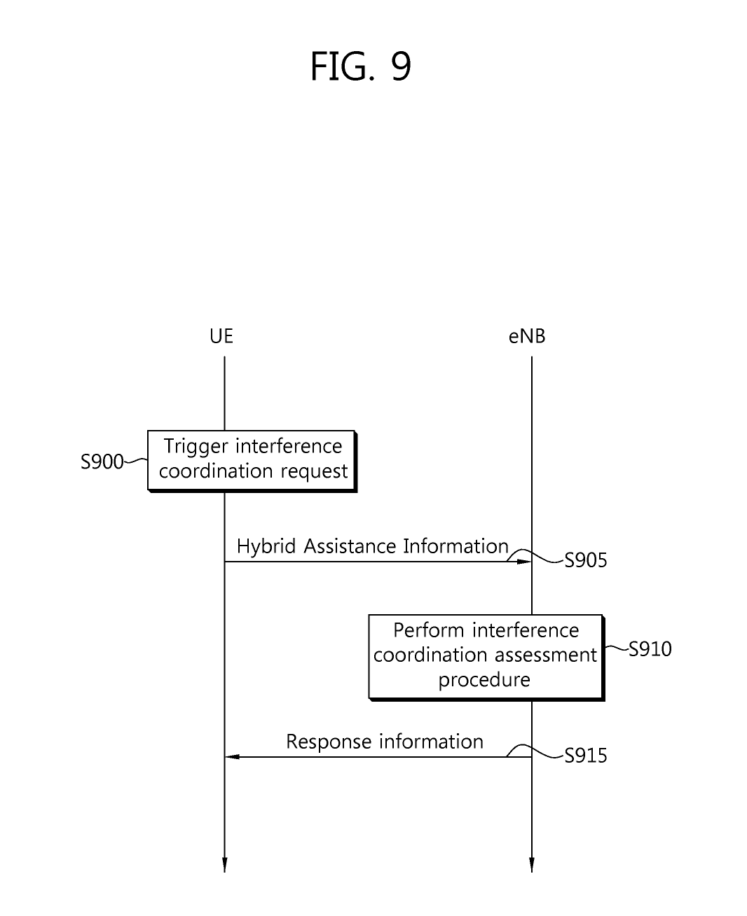

FIG. 9 is a flowchart illustrating a method of coordinating IDC interference based on the mixed method in accordance with an example of the present invention.

Referring to FIG. 9, when IDC interference is detected, UE triggers a request to coordinate the IDC interference at step S900. The IDC interference corresponds to, for example, a case where transmission using Bluetooth or WiFi from the UE to a peripheral device generates interference with reception from an eNB in the LTE system of the UE. Alternatively, the IDC interference may correspond to a case where transmission from the UE to an LTE system generates interference with reception from a peripheral device that performs communication using Bluetooth or WiFi.

For example, in a situation, such as that of FIG. 2, the UE determines whether or not a transmission signal having a different RF generates interference with a reception signal having an LTE RF. For example, the UE can detect IDC interference using a Signal to Interference Noise Ratio (SINR). For another example, the UE can detect IDC interference using Reference Signal Received Power (RSRP) or Reference Signal Received Quality (RSRQ). For example, it is assumed that the UE sends a signal ‘y’ through a different RF, such as WiFi, while receiving a signal ‘x’ from an eNB through an LTE RF. Here, if the SINR of the signal ‘y’ becomes a threshold or higher and functions as interference with the signal ‘x’, the UE can detect IDC interference. When the IDC interference is detected, the UE triggers a request to coordinate the IDC interference.

When the interference coordination request is triggered, the UE sends Hybrid Assistance Information (HAI), supporting that the reduction, avoidance, or removal of interference is performed in a frequency domain or a time domain, to an eNB at step S905. An operation of reducing, avoiding, or removing interference is hereinafter collectively called ‘interference coordination’.

The HAI includes first assistance information that supports interference coordination based on the FDM scheme and second assistance information that supports interference coordination based on the TDM scheme. The second assistance information can include a TDM pattern. The UE can further include an identifier for distinguishing the first assistance information and the second assistance information in the HAI so that the eNB can distinguish the first assistance information and the second assistance information. Here, the identifier can be transmitted through a Medium Access Control (MAC) message or physical layer signaling. Alternatively, the UE can configure the first assistance information and the second assistance information in the form of a message having each Information Element (IE) so that the eNB can distinguish the first assistance information from the second assistance information. The IE can be included in a Radio Resource Control (RRC) message.

The HAI can further include an application indicator indicative of a frequency band or a cell to which the second assistance information will be applied according to the TDM scheme. If the number of frequency bands or cells in which IDC interference is generated is 2 or more, interference coordination needs to be performed on each band or cell according to different second assistance information (or a TDM pattern). That is, the number of TDM patterns for interference coordination may be plural. In this case, the UE needs to inform the eNB that what TDM pattern is applied to the interference of what band or cell. Information used to this end is the application indicator.

The type of HAI may be a message generated in a Radio Resource Control (RRC) layer or a Medium Access Control (MAC) layer or may be physical layer signaling. The HAI is described in detail later.

When the HAI is received, the eNB considers the HAI to be an interference coordination request from the UE and performs an assessment procedure in response to the request at step S910. The assessment procedure can be individually performed on each frequency band (or cell) in which interference is generated. Alternatively, the assessment procedure can be performed on all the frequency bands (or cells) in which interference is generated at once.

A method of the eNB performing the assessment procedure can be subdivided as follows. First, the eNB assesses that to use what interference coordination scheme is appropriate. For example, the eNB can assess an interference coordination scheme based on priority. That is, the eNB first assess a possibility that a first interference coordination scheme can be applied and then assess a possibility that a second interference coordination scheme can be applied. For example, the eNB can first assess whether or not the FDM scheme can be applied to interference coordination. If, as a result of the assessment, the FDM scheme cannot be applied, the eNB can assess whether or not the TDM scheme can be applied to the interference coordination. On the contrary, the eNB may first assess whether or not the TDM scheme can be applied to interference coordination and then assess whether or not the FDM scheme can be applied to the interference coordination.

For another example, the eNB can simultaneously assess whether or not the FDM scheme and the TDM scheme can be applied to interference coordination. That is, the eNB assesses a possibility that the FDM scheme and the TDM scheme can be applied to interference coordination simultaneously or in parallel. For this assessment, a cost function to be described later can be used.

The eNB selects an interference coordination scheme that is determined to be appropriate based on the assessment and performs interference coordination based on the selected interference coordination scheme and corresponding assistance information. Meanwhile, there is a case where different types of interference can be generated in different bands. In this case, the eNB can apply the same interference coordination scheme or different interference coordination schemes to the different bands at once. For example, it is assumed that IDC interference is generated in a CC1, a CC2, and a CC3 while UE performs communication through the CC1, the CC2, and the CC3. In this case, an eNB can apply the FDM scheme to the CC1 and the CC2 and apply the TDM scheme to the CC3. Alternatively, the eNB can apply the FDM scheme or the TDM scheme all the CC1, CC2, and CC3. As described above, the eNB may apply a different interference coordination scheme to each band in which interference is generated or may apply the same interference coordination scheme to all the bands.

If, as a result of the assessment, both the interference coordination schemes are assessed not to be appropriate, the eNB may not perform interference coordination. In this case, the eNB may not perform any operation or may generate response information indicating that interference coordination is rejected.

The eNB sends response information to the UE at step S915. The response information can indicate that the interference coordination request is accepted or rejected.

Response information indicating that the interference coordination request is accepted can have a different form depending on whether a scheme selected in the assessment procedure is the FDM or TDM scheme. For example, if the FDM scheme is selected, response information indicating that the interference coordination request is accepted can be a cell reconfiguration message in a cell reconfiguration procedure, a handover command message in a handover procedure, a frequency shift indicator indicating that a band in which interference is generated needs to be shifted by a specific frequency offset, or a frequency shaping indicator indicating that some of a band in which interference is generated needs to be shaped.

For another example, if the TDM scheme is selected, response information indicating that the interference coordination request is accepted can be a discontinuous reception (DRX) reconfiguration message in a DRX procedure, a DRX command message, or an acknowledgement (ACK) signal.

Response information that indicates the rejection of interference coordination can be a non-acknowledgement (NACK) signal. Interference can be coordinated more efficiently by properly supplementing the advantages and disadvantages of the TDM scheme and the FDM scheme and mixing the two schemes as described above.

The first assistance information, the second assistance information, the identifier, and the application indicator that may be included in the HAI are described in detail below.

1. First Assistance Information

The first assistance information includes a measurement result. That is, the first assistance information includes a measurement result, such as a Signal to Interference plus Noise Ratio (SINR), Reference Signal Received Power (RSRP), or Reference Signal Received Quality (RSRQ). For another example, the first assistance information includes an avoidance indicator, indicating that IDC interference based on the FDM scheme needs to be avoided, along with the measurement result.

RSRQ is calculated as the mean value over a specific cycle (e.g., 200 ms). The mean value can be greatly different depending on device conditions because IDC interference is irregular interference generated in different wireless systems. Accordingly, the first assistance information that is reported by UE when IDC interference is generated can be different from assistance information when IDC interference is not generated. The first assistance information reported in an IDC condition can be classified into four types as follows.

(1) First assistance information including a measurement result into which IDC interference has been incorporated: In this type of assistance information, IDC interference is incorporated in the measurement result. For example, it is assumed that DL CCs CC1, CC2, and CC3 have been configured in UE and IDC interference is generated in the CC 1. In this case, the RSRQ of each of the CC1, the CC2, and the CC3 is listed in Table 2.

TABLE 2

| CC | RSRQ |
|---|---|
| CC1 | $\frac{{S}_{1}}{{I}_{1} + {N}_{1}}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 2, Sₙ is the intensity of the reception signal of a CCn, Iₙ is the intensity of an interference signal that is generated from a CCn, and Nₙ is the intensity of noise that is generated from a CCn. Here, assuming that the intensity of IDC interference generated from the CC1 is I′, a measurement result included in the first assistance information is listed in Table 3.

TABLE 3

| CC | RSRQ |
|---|---|
| CC1 | $\frac{{S}_{1}}{{I}_{1} + {I}^{′} + {N}_{1}}$ |
| CC2 | $\frac{{S}_{2}}{{I}_{2} + {N}_{2}}$ |
| CC3 | $\frac{{S}_{3}}{{I}_{3} + {N}_{3}}$ |

Table 3 differs from Table 2 in that I′ has been added to the denominator of the measurement result in the CC1.

(2) First assistance information including a measurement result in which RSRQ is separated from IDC interference: The intensity of interference is additionally used as a measurement result in addition to RSRQ. In this case, the measurement result can be represented as in Table 4.

TABLE 4

| CC | RSRQ |
|---|---|
| CC1 | $\frac{{S}_{1}}{{I}_{1} + {N}_{1}} , {I}^{′}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 4, the measurement result regarding the CC1 includes both S₁/(I₁+N₁) and I. That is, the measurement result included in the first assistance information has a form in which I′ is additionally reported in addition to existing reported RSRQ.

(3) First assistance information including a usable band indicator and an unusable band indicator: A CC in which DC interference is generated is an unusable frequency band that cannot be used by UE. In contrast, a CC in which IDC interference is not generated is a usable frequency band that can be used by UE. Accordingly, UE can configure the first assistance information, including a usable band indicator indicative of a CC having a usable frequency band and an unusable band indicator indicative of a CC having an unusable frequency band. In the example of Table 4, an unusable band indicator is {1}, and a usable band indicator is {2, 3}.

The usable band indicator and the unusable band indicator indicate a frequency band corresponding to a specific serving cell that is formed of at least one CC. For example, a DL CC linked to one DL CC through SIB2 can be configured as one serving cell, or one DL CC may be configured as one serving cell.

(4) First assistance information including the strength of IDC interference: When IDC interference is generated, UE configures the first assistance information so that the strength of IDC interference regarding a corresponding CC is indicated. For example, the strength of IDC interference may be {I′, 0, 0}, and mapping to the CC1, the CC2, and the CC3 is performed sequentially from the left. Alternatively, UE may configure the first assistance information in such a way as to inform information about a frequency band itself, such as a region that is possible in a real frequency band and a region that is impossible in a real frequency band. Here, the one CC may configure one serving cell, or a set of a DL CC and a UL CC linked together may configure one serving cell. A scheme for indicating the strength of IDC interference can be configured in a serving cell form for a CC.

(5) First assistance information including an RSRQ measurement result from which IDC interference has been removed:

Here, an RSRQ value from which IDC interference has been removed means an RSRQ value obtained by filtering measurement samples from which measurement samples influenced by IDC interference within UE have been removed. That is, the RSRQ value from which IDC interference has been removed is a value that has not been greatly influenced by IDC interference.

(6) First assistance information including an RSRQ measurement result from which IDC interference has been removed and an RSRQ measurement result including IDC interference:

Here, an RSRQ value including IDC interference means an RSRQ value obtained by filtering measurement samples that have been influenced by IDC interference. That is, the RSRQ value including IDC interference will be a value that is influenced by IDC interference. Furthermore, the RSRQ value including IDC interference may be a result obtained by filtering only measurement samples influenced by IDC interference or may be a result obtained by filtering measurement samples, including both measurement samples influenced by IDC interference and measurement samples not influenced by IDC interference.

(7) First assistance information including an RSRQ measurement result from which IDC interference has been removed and an RSRQ measurement result including IDC interference in the form of a different value:

Here, a difference value from an RSRQ value including IDC interference can be sent up on the basis of a value not including IDC interference. For example, assuming that an RSRQ value not including IDC interference is 8 dB and an RSRQ value including IDC interference is 5 dB, the first assistance information can include 8 dB, −3 dB.

The first assistance information may be configured in one of the forms according to the proposed embodiments or may be configured in a form in which one or more of the embodiments are combined. For example, a measurement result of RSRQ from which IDC interference has been removed may be further included along with the usable band indicator and the unusable band indicator.

2. Second Assistance Information

The second assistance information can be defined in various ways depending on a point of view. For convenience of description, it is assumed that transmission (Tx) in a first frequency band of a first network system generates interference with reception (Rx) in a second frequency band of a second network system at an interference interval T₁ to T₂ in each cycle, but does not generate interference at a non-interference interval T₂ to T₃. The first network system can be called an aggressor system because it provides interference, and the second network system can be called a victim system because it is subject to interference.

If an eNB is already aware of the interference interval T₁ to T₂ or the non-interference interval T₂ to T₃, the eNB can coordinate interference based on the TDM scheme by taking the intervals.

For example, the eNB can perform scheduling so that the Tx is performed in the non-interference interval T₂ to T₃ not in the interference interval T₁ to T₂. In contrast, the eNB can perform scheduling so that priority is placed higher in the victim system than in the aggressor system because the Rx continues to be generated in the interference interval T₁ to T₂. Here, the eNB can be an eNB of an aggressor system.

For another example, the eNB can perform scheduling so that the Rx is performed in the non-interference interval T₂ to T₃ not in the interference interval T₁ to T₂. In contrast, the eNB can perform scheduling so that priority is placed higher in the aggressor system than in the victim system because the Tx continues to be generated in the interference interval T₁ to T₂. Here, the eNB can be an eNB of an aggressor system.

Whether or not to perform interference coordination according to the TDM scheme by prioritizing any system as described above may be previously agreed between UE and an eNB or may be determined by an eNB according to its scheduling. For example, assuming that an aggressor system is a WiFi system and important information, such as system information, is transmitted in the interference interval T₁ to T₂, the system information has relatively higher priority. Accordingly, if the WiFi system generates interference with another system in the interference interval T₁ to T₂, an eNB performs scheduling so that the transmission and reception of another system are not performed in the interference interval T₁ to T₂.

From a viewpoint of a system having low priority, an interference interval can be defined as an unusable interval, and a non-interference interval can be defined as a usable interval. In either case, if UE informs an eNB of the interference interval (or unusable interval) or the non-interference interval (or usable interval), the eNB can perform interference coordination with reference to the interference interval or the non-interference interval.

From this point of view, the second assistance information may be information indicative of an interference interval (or unusable interval) or a non-interference interval (or usable interval). The second assistance information can be classified into four types as follows.

(1) Second Assistance Information Indicating an Interference Interval or a Non-Interference Interval for a Specific Time Cycle in a Bitmap Form

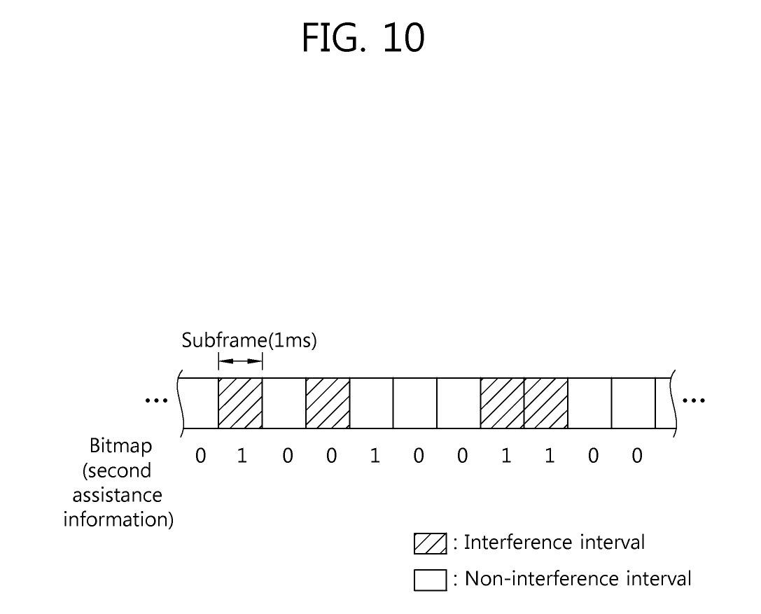

FIG. 10 is a diagram illustrating the second assistance information in accordance with an example of the present invention.

Referring to FIG. 10, a frame structure in LTE includes a plurality of subframes, and each subframe is 1 ms. Assuming that an interference interval is defined per subframe, 1 bit that forms a bitmap corresponds to one subframe. For example, if the bitmap is ‘1’, it indicates that a corresponding subframe is an interference interval. If the bitmap is ‘0’, it indicates that a corresponding subframe is a non-interference interval. In some embodiments, intervals indicated by the bitmap ‘1’ and ‘0’ may be defined contrary to that described above. The interference interval has been illustrated as being defined per subframe in FIG. 10, but this is only an example. For example, n subframes can be grouped to correspond to one bit as one interference interval. The interference interval does not need to be necessarily a subframe unit, but may be defined as a specific time interval t, such as 1.5 ms or 0.8 ms. Furthermore, from a viewpoint that an LTE system is available or unavailable, the bitmap ‘1’ may be defined as a usable interval, and the bitmap ‘0’ may be defined as an unusable interval.

A bitmap indicative of an interference interval/non-interference interval in UL may be distinguished from a bitmap indicative of an interference interval/non-interference interval in DL, and an interference interval and a non-interference interval may be indicated by one bitmap irrespective of UL and DL.

(2) Second Assistance Information Indicative of a Time Interval that Cannot be Scheduled (or Time Interval that can be Scheduled)

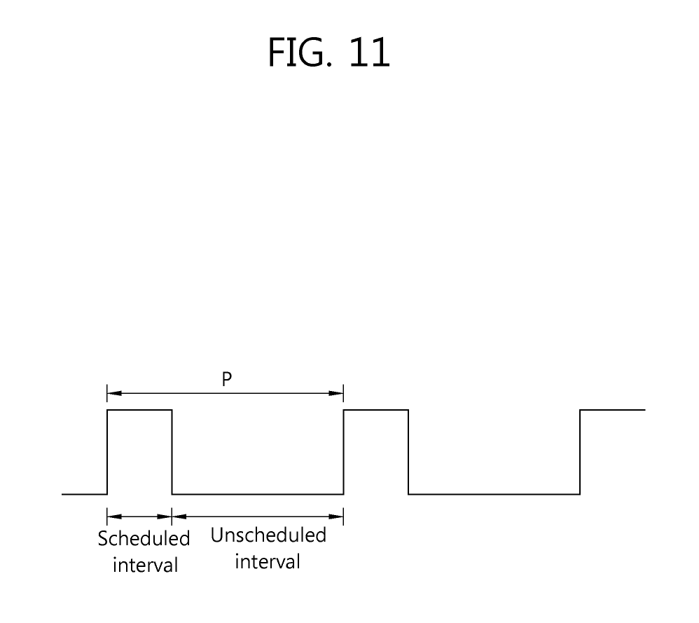

FIG. 11 is a diagram illustrating the second assistance information in accordance with another example of the present invention.

Referring to FIG. 11, a scheduled interval and an unscheduled interval are repeated every cycle P regarding UE. The scheduled interval refers to an interval in which scheduling for UE is possible in a specific network system, and the unscheduled interval refers to an interval in which scheduling for UE is impossible in a specific network system.

Accordingly, UE can send information about one of the scheduled interval and the unscheduled interval or information about both the scheduled interval and the unscheduled interval to an eNB as the second assistance information.

(3) Second Assistance Information Indicating a Scheduled Interval or an Unscheduled Interval within a DRX Cycle

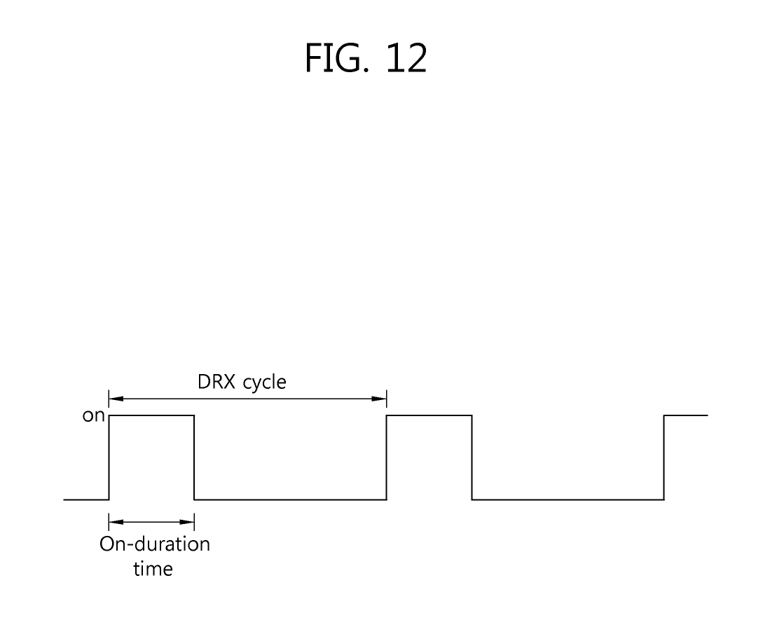

FIG. 12 is a diagram illustrating the second assistance information in accordance with yet another example of the present invention.

Referring to FIG. 12, UE can operate in DRX mode in which a signal is not received for a specific time according to a specific DRX cycle. A parameter for determining DRX mode includes a DRX cycle, an on-duration time, and an inactivity timer. The DRX cycle is a cycle in which UE wakes up in DRX mode. The on-duration time is the time during which a wake-up state periodically continues.

UE can determine whether a PDCCH scheduled for the UE is present or not in the on-duration time. If, as a result of the determination, it is determined that a PDCCH scheduled for the UE is present in the on-duration time, the UE maintains a wake-up state until the scheduling expires. A point of time at which the scheduling expires will be from a point of time at which the PDCCH was finally scheduled to a point of time at which an inactivity timer expires. In contrast, if, as a result of the determination, it is determined that a PDCCH scheduled for the UE is not present in the on-duration time, the UE enters a inactivity time in DRX mode again after a lapse of the on-duration time.

Here, if the transmission or reception timing of UE in DRX mode is to be changed by interference coordination based on the TDM scheme, the change needs to be changed within a range that does not affect at least the operation of the DRX cycle. For example, if there is a condition that the transmission or reception of UE should be performed in an on-duration time, but should not be performed in a inactivity time, UE needs to inform an eNB of its on-duration time or inactivity time. In this case, the eNB does not allow scheduling for the UE in the inactivity time when performing interference coordination.

For example, the second assistance information includes information about an on-duration time or a inactivity time itself. For another example, the second assistance information includes information about a ratio of a inactivity time to a DRX cycle. For example, if a DRX cycle is 4 ms and a inactivity time is 3 ms, a ratio of the inactivity time to the DRX cycle is 3/4, and information about the ratio is included in the second assistance information.

(4) Second assistance information including information about an increase of an unscheduled interval: In relation to information about an increase of an unscheduled interval, an increment or decrement may be delivered. The information about an increase of an unscheduled interval may be increased or decreased in a multiple form or in an added form. If the information about an increase of an unscheduled interval is increased or decreased in a multiple form, the second assistance information can have an N or 1/N form. For example, it is assumed that ¼ was an unscheduled interval in relation to the entire DRX cycle. If an increment having a multiple form is 2, an unscheduled interval will become ½. If an increment having a multiple form is ½, an unscheduled interval will become ⅛. If the information about an increase of an unscheduled interval is increased or decreased in an added or subtracted form, a given value will be added or subtracted. For example, if ¼ is given, it will lead to ¼+¼=½. If −⅛ is given, it will lead to ¼−⅛=⅛.

(5) Second assistance information including an ACK indicator: This case is as follows. If UE has made an interference coordination request based on the FDM scheme, but an eNB has recommended interference coordination based on the TDM scheme, the UE triggers the interference coordination request based on the TDM scheme and sends the second assistance information, including an ACK indicator, to the eNB.

The second assistance information may be configured differently in UL and DL and transmitted, or a piece of second assistance information may be determined and transmitted.

3. An Application Indicator

The application indicator indicates a frequency band or a cell. Accordingly, information related to the frequency or cell can be used as the application indicator. For example, information about a cell index, a frequency band index, or a frequency band value itself can become the application indicator. An example of the frequency band index is a band index defined in International Mobile Telecommunication (IMT). That is, the band index can be given like #40, #7, #13, or #1.

The application indicator may be included in Hybrid Assistance Information (HAI) or may not be included in HAI.

First, if the application indicator is included in HAI, the application indicator is used to explicitly indicate interference from a frequency band or a cell to which the second assistance information is applied. For example, if interference coordination based on the TDM scheme is performed on a single frequency band fₐ, the second assistance information is applied to a single frequency band fₐ indicated by the application indicator. For another example, it is assumed that interference coordination based on the TDM scheme is performed on each of a plurality of frequency bands fₐ and f_{b} and HAI includes second′ assistance information, second″ assistance information, a first application indicator indicating fₐ, and a second application indicator indicating f_{b}. The second′ assistance information is applied to fₐ because the first application indicator corresponds to the second′ assistance information. Likewise, the second″ assistance information is applied to f_{b} because the second application indicator corresponds to the second″ assistance information.

Next, if the application indicator is not included in HAI, an implicit rule is necessary regarding that the second assistance information is used for interference coordination regarding what frequency band (or cell). This differs depending on whether the number of frequency bands (or cells) in which interference is generated is one or plural.

i) If the TDM Scheme is Applied to a Single Frequency Band (or Cell) Only:

This is considered that the second assistance information is applied to a current frequency band (or cell) in which UE operates.

ii) If the TDM Scheme is Applied to a Plurality of Frequency Bands (or Cells)

For example, an eNB can sequentially apply the second assistance information to frequency bands (or cells) in which interference is generated in order to interpret the frequency bands (or cells). For example, if interference is generated in frequency bands f₁, f₄, and f₅, second′ assistance information, second″ assistance information, and second′″ assistance information can be sequentially applied to interference coordination for f₁, f₄, and f₅, respectively.

For another example, an eNB can apply only a piece of second assistance information to all frequency bands (or cells) in which interference is generated in order to interpret the frequency bands (or cells).

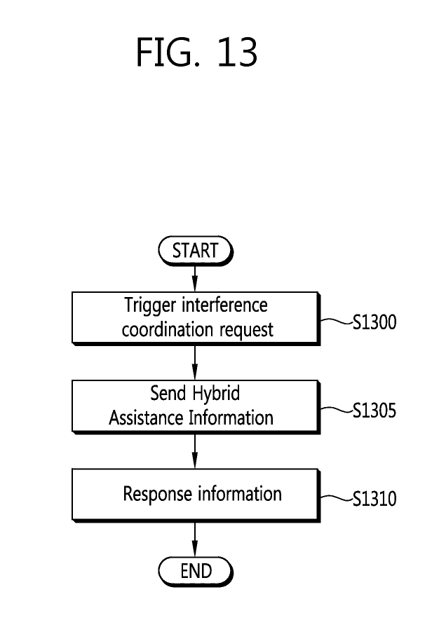

FIG. 13 is a flowchart illustrating a method of UE performing interference coordination in accordance with an example of the present invention. The method of FIG. 13 corresponds to a case where UE does not include a timer for the reception of response information.

Referring to FIG. 13, the UE detects the occurrence of IDC interference and triggers an interference coordination request at step S1300. For example, the UE can detect the occurrence of IDC interference based on an SINR. For another example, the UE can detect the occurrence of IDC interference based on RSRP or RSRQ.

When the interference coordination request is triggered, the UE sends HAI for the interference coordination to an eNB at step S1305. The HAI includes first assistance information and second assistance information. The HAI can further include an identifier for distinguishing the first assistance information and the second assistance information. Alternatively, the first assistance information and the second assistance information can be distinguished based on each Information Element (IE). The HAI can further include an application indicator indicative of a frequency band or a cell to which the second assistance information will be applied according to the TDM scheme.

The UE receives response information from the eNB at step S1310. The response information indicative of the acceptance of the interference coordination request can have a different form depending on whether a scheme selected in an assessment procedure is the FDM or TDM scheme. For example, if a scheme selected in an assessment procedure is the FDM scheme, the response information indicative of the acceptance of the interference coordination request can be a cell reconfiguration message in a cell reconfiguration procedure, a handover command message in a handover procedure, a frequency shift indicator indicating that a band in which interference is generated needs to be shifted by a specific frequency offset, or a frequency shaping indicator indicating that some of a band in which interference is generated needs to be shaped.

For another example, if a scheme selected in an assessment procedure is the TDM scheme, the response information indicative of the acceptance of the interference coordination request can be a DRX reconfiguration message in a DRX procedure, a DRX command message, or an ACK signal.

Meanwhile, the response information indicative of the rejection of the interference coordination request can be NACK.

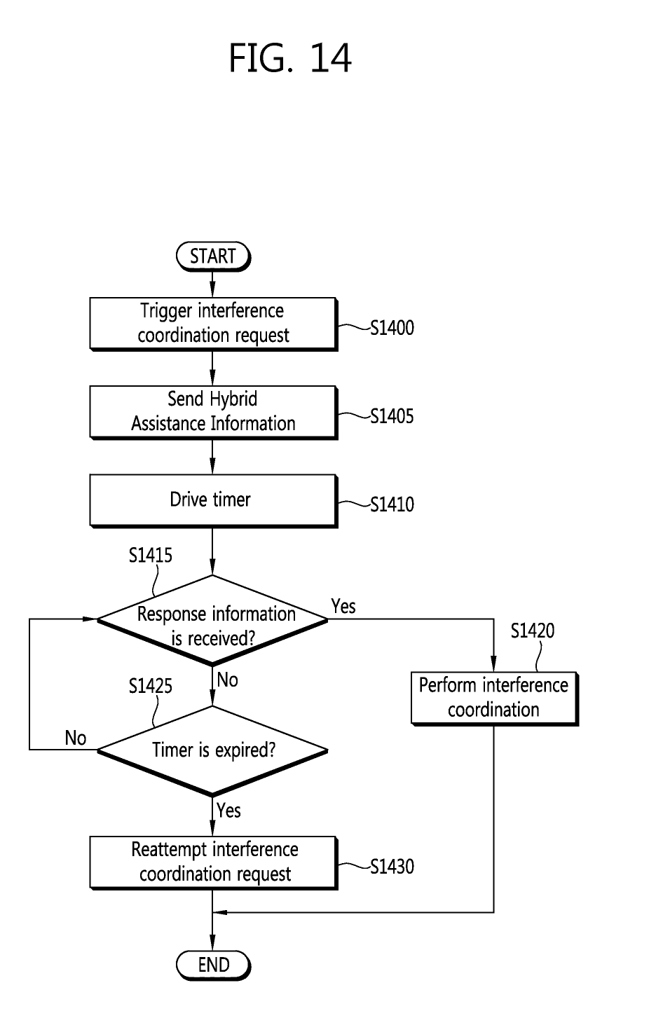

FIG. 14 is a flowchart illustrating a method of UE performing interference coordination in accordance with another example of the present invention. The method of FIG. 14 corresponds to a case where a timer that enables UE to receive response information operates.

Referring to FIG. 14, steps S1400 and S1405 are the same as steps S1300 and S1305 of FIG. 13, and thus a detailed description thereof is omitted. After sending HAI, the UE drives a timer at step S1410. Before the timer expires, the UE determines whether or not response information is received from an eNB at step S1415. If, as a result of the determination, it is determined that response information is received from the eNB before the timer expires, the UE performs interference coordination at step S1420. Here, the interference coordination is performed according to an interference coordination scheme determined based on the response information. If, as a result of the determination, it is determined that response information is not received from the eNB before the timer expires, the UE determines whether or not the timer has expired at step S1425. If, as a result of the determination at step S1425, it is determined that the timer has expired, the UE reattempts an interference coordination request or terminates the interference coordination procedure at step S1430. If, as a result of the determination at step S1425, it is determined that the timer has not expired, the UE determines whether or not response information is received at step S1415.

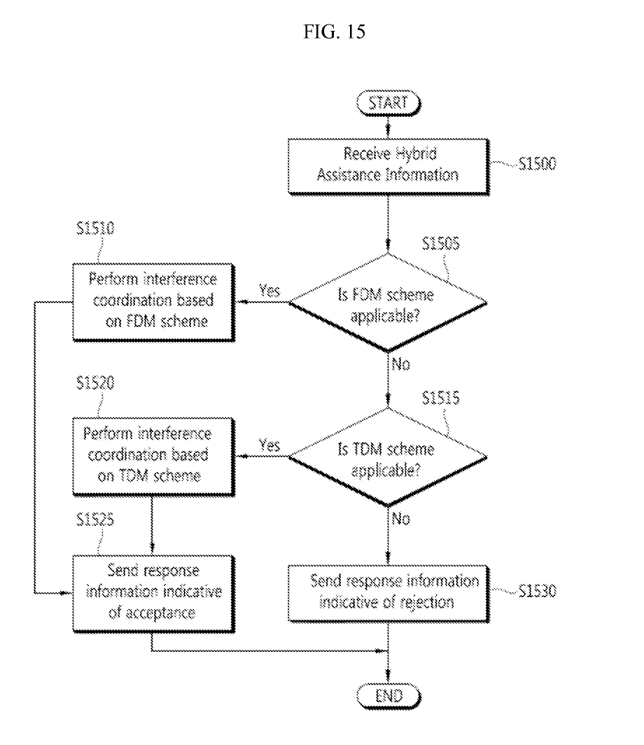

FIG. 15 is a flowchart illustrating a method of an eNB performing interference coordination in accordance with an example of the present invention. The method of performing interference coordination of FIG. 15 can be applied to each frequency band (or cell) in which interference is generated. Alternatively, the method of performing interference coordination of FIG. 15 can be applied to all the frequency bands (or cells) in which interference is generated at once. For example, assuming that cells configured in UE are a CC1, a CC2, and a CC3 and all the CC1, CC2, and CC3 experience IDC interference, interference coordination can be individually applied like CC1:FDM, CC2:TDM, and CC3: FDM or can be at once applied like CC1,CC2,CC3:FDM.

Referring to FIG. 15, the eNB receives HAI from UE at step S1500. The HAI includes the first assistance information and the second assistance information. The HAI can further include the identifier or the application indicator. First, the eNB assesses whether or not the FDM scheme can be applied to interference coordination according to priority at step S1505. A criterion for the assessment is as follows.

For example, the eNB can assess a possibility that the FDM scheme can be applied to interference coordination based on the capacity of available resources in an avoidance band. A band indicated by a usable band indicator is called an avoidance band because it can avoid IDC interference. The eNB calculates the capacity of available resources in an avoidance band. The capacity of available resources can mean the amount of available radio resources except radio resources that have been allocated to UEs by the eNB in the avoidance band. If the capacity of available resources in the avoidance band is not sufficient, the eNB will not accept the mobility of the UE to the avoidance band according to the FDM scheme. In contrast, if the capacity of available resources in the avoidance band is sufficient, the eNB can perform interference coordination by accepting the mobility of the UE to the avoidance band.

For another example, the eNB can assess a possibility that the FDM scheme can be applied to interference coordination based on a measurement result, such as RSRP or RSRQ. Mobility to a frequency band having low RSRP or RSRQ may not be a preferred condition from a viewpoint of the eNB and the UE. Accordingly, if an RSRP or RSRQ value is too low although an avoidance band has been assessed to have the capacity of available resources based on a determination of the capacity of available resources and priority of RSRP or RSRQ, the eNB does not accept the mobility of the UE to the avoidance band.

If it is determined that the FDM scheme can be applied to interference coordination according to the assessment criterion, the eNB performs interference coordination based on the FDM scheme at step S1510. The first assistance information is used for the interference coordination. Next, the eNB sends response information indicative of acceptance to the UE at step S1525. Although step S1525 has been illustrated as being performed after step S1510, this is only an example. Alternatively, step S1510 may be performed after step S1525, or steps S1510 and S1525 may be performed at the same time. Here, the response information indicative of acceptance can be any one of a cell reconfiguration message, a handover message, a frequency shift indicator, and a frequency shaping indicator. Alternatively, the response information indicative of acceptance can include ACK.

If the response information is accompanied by a specific operation, such as a cell reconfiguration message or an RRC reconfiguration message, acceptance or rejection can be implicitly determined depending on how an operation is performed in response to a corresponding request. For example, it is assumed that interference is generated from a plurality of frequency bands (or cells) CC1 and CC2. When an eNB sends an RRC reconfiguration message for changing a CC1, a CC2, and a CC3 configured in UE into a CC2, a CC3, and a CC4, respectively, to UE as response information, the UE can determine that the eNB has accepted an interference coordination request for the CC1, but has rejected an interference coordination request for the CC2.

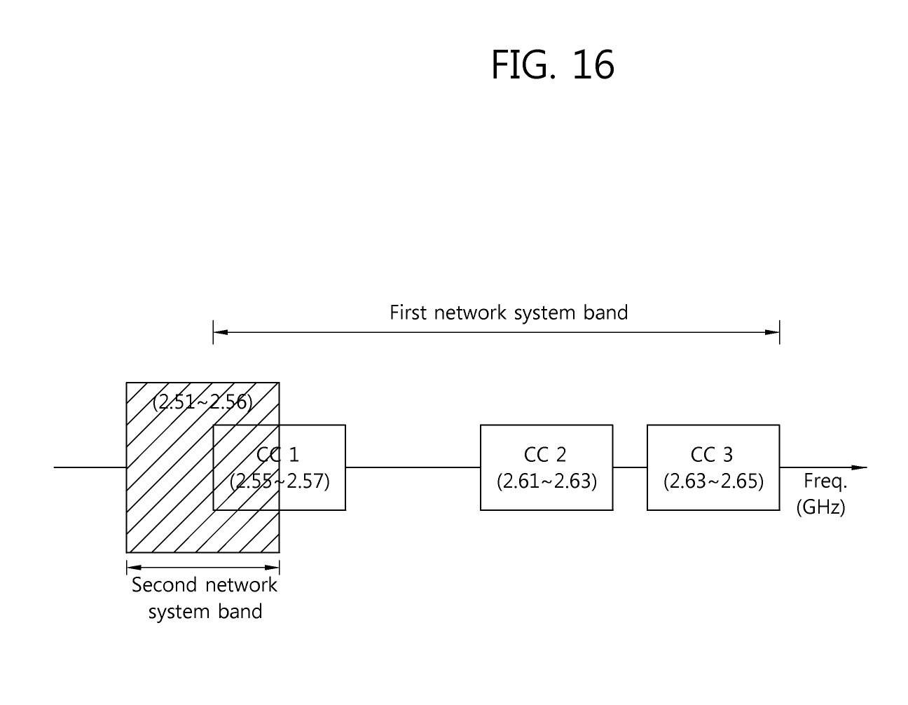

A frequency shift and frequency shaping is described with reference to FIGS. 16 to 18.

FIGS. 16 to 18 are diagrams illustrating a method of coordinating IDC interference by way of a frequency shift or shaping in accordance with an example of the present invention.

Referring to FIG. 16, in a first network system, the band of a CC1 is 2.55 to 2.57 GHz, the band of a CC2 is 2.61 to 2.63 GHz, and the band of a CC3 is 2.63 to 2.65 GHz. In a second network system, a frequency band is 2.51 to 2.56 GHz. In this case, IDC interference can be generated because the band of 2.55 to 2.57 GHz in the CC1 of the first network system overlaps with the band of 2.55 to 2.56 GHz in the second network system. Here, the first network system can be a 3^{rd} Partnership Project (3GPP) Long Term Evolution (LTE) system, and the second network system can be a Bluetooth or WiFi system. When UE sends assistance information to an eNB because of the IDC interference, the eNB sends response information indicative of acceptance or rejection to the UE.

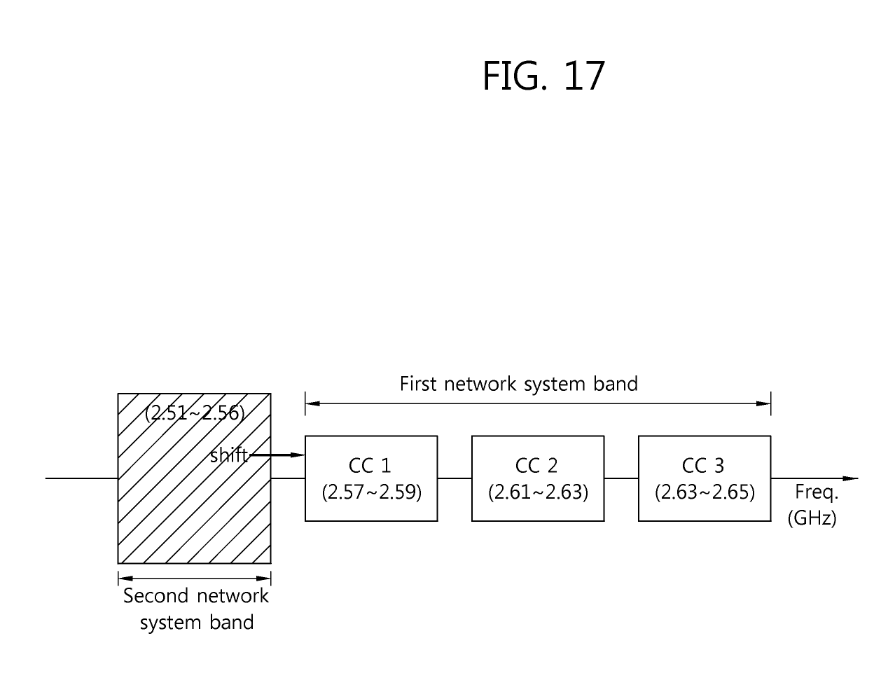

For example, an eNB can shift a band in which interference is generated, which is called a ‘frequency shift’. That is, the eNB shifts the CC1 in the first network system, that is, a band in which interference is generated, by an offset of 0.02 GHz as in FIG. 17. As a result, the band of the CC1 is changed into 2.57 to 2.59 GHz, and thus IDC interference between the CC1 and the second network system can be removed. Meanwhile, the eNB informs the UE that the frequency shift is performed using response information, which is called a frequency shift indicator. The frequency shift indicator can be an RRC message, a MAC message, or physical layer signaling.

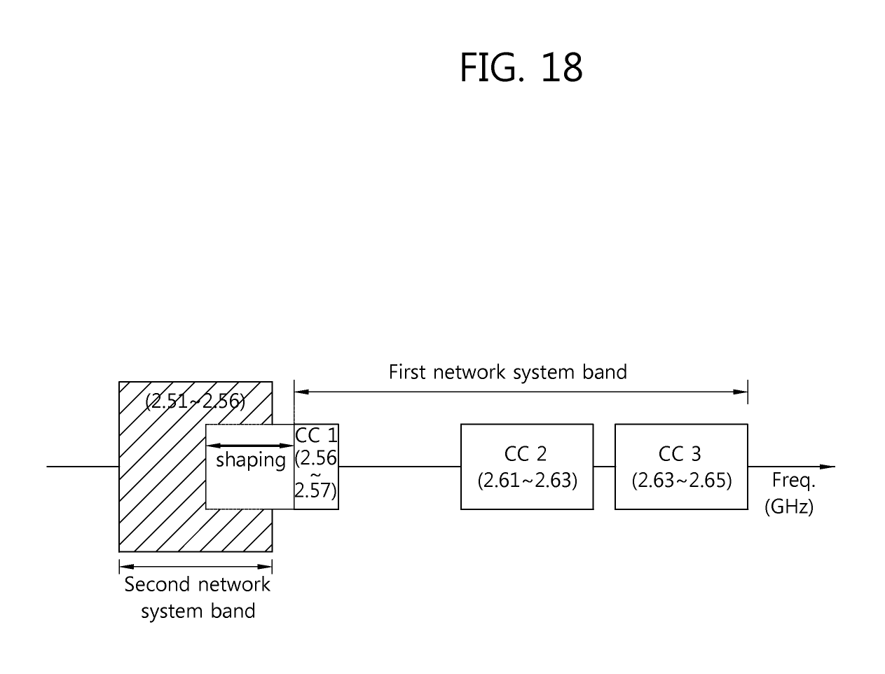

For another example, the eNB can shape a band in which interference is generated, which is called ‘frequency shaping’. That is, the eNB rips off a part of the CC1 which generates interference with the band of the second network system by 0.01 GHz as in FIG. 18. Here, to rip off a part of the frequency band may correspond to a change of a physical filtering characteristic (e.g., the number of taps) or may mean that the eNB limitedly schedules resources for a corresponding band. That is, the allocation of resources for UE is limited to a band Fₓ.

Through frequency shaping, the band of the CC1 can be changed into 2.56 to 2.57 GHz, and IDC interference between the CC1 and the second network system can be removed. Meanwhile, the eNB informs the UE that the frequency shaping is performed using response information, which is called a ‘frequency shaping indicator’. The frequency shaping indicator can be an RRC message, a MAC message, or physical layer signaling.

Referring back to FIG. 15, if, as a result of the determination at step S1505, it is determined that the FDM scheme cannot be applied to interference coordination, the eNB assesses whether or not the TDM scheme can be applied to interference coordination at step S1515. If, as a result of the determination at step S1515, it is determined that the TDM scheme can be applied to interference coordination, the eNB performs interference coordination based on the TDM scheme at step S1520. The second assistance information is used for the interference coordination based on The TDM scheme. As an example of the interference coordination, the eNB can perform scheduling based on an interference interval and a non-interference interval. For example, the eNB can perform scheduling so that the transmission or reception of the UE is not performed in the interference interval, but is performed in the non-interference interval.

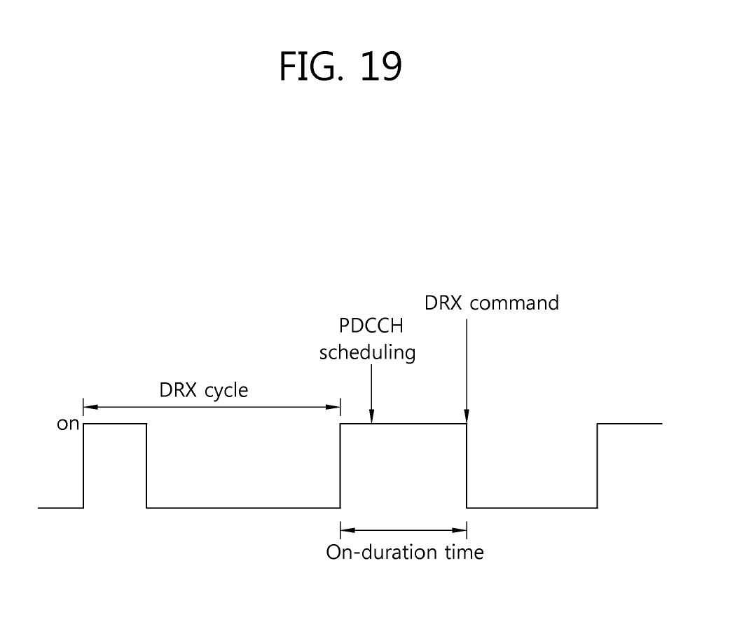

As another example of the interference coordination, the eNB performs a DRX procedure. This example corresponds to a case where UE operates in DRX mode and assistance information received from the UE indicates a scheduled interval or an unscheduled interval within a DRX cycle. The DRX procedure can be a DRX command or a DRX reconfiguration procedure. In particular, if interference coordination is performed in response to a DRX command, the UE can operate as in FIG. 19. Referring to FIG. 19, when PDCCH scheduling is performed within a DRX cycle, UE maintains an on-duration time. Thereafter, when a DRX command is received, the UE enters an inactivity time. Meanwhile, if interference coordination is performed as a DRX reconfiguration procedure, the eNB can coordinate interference by changing a DRX configuration parameter.

Thereafter, the eNB sends response information indicative of acceptance to the UE at step S1525. For example, the response information indicative of acceptance can be a DRX reconfiguration message. For another example, the response information indicative of acceptance can be a DRX command message. For yet another example, the response information indicative of acceptance can include ACK.

If, as a result of the determination at step S1515, it is determined that the TDM scheme cannot be applied to interference coordination, the eNB sends response information indicative of rejection to the UE at step S1530. Here, the response information indicative of rejection can include the second assistance information (or TDM pattern) having a new parameter or can include NACK. Alternatively, the eNB may not send the response information itself to the UE.

If the response information includes ACK or NACK, it is necessary to determine whether the ACK or NACK is related to the TDM scheme or the FDM scheme. To this end, the response information can further include scheme identification information regarding whether the ACK or NACK corresponds to what scheme. For example, if the response information is ACK regarding the TDM scheme and is NACK regarding the FDM scheme, the eNB sends first scheme identification information, including identification information indicative of the TDM scheme and ACK, and sends second scheme identification information, including identification information indicative of the FDM scheme and NACK. Alternatively, the eNB may include a piece of information in which the first scheme identification information and the second scheme identification information are integrated in the response information and send the response information.

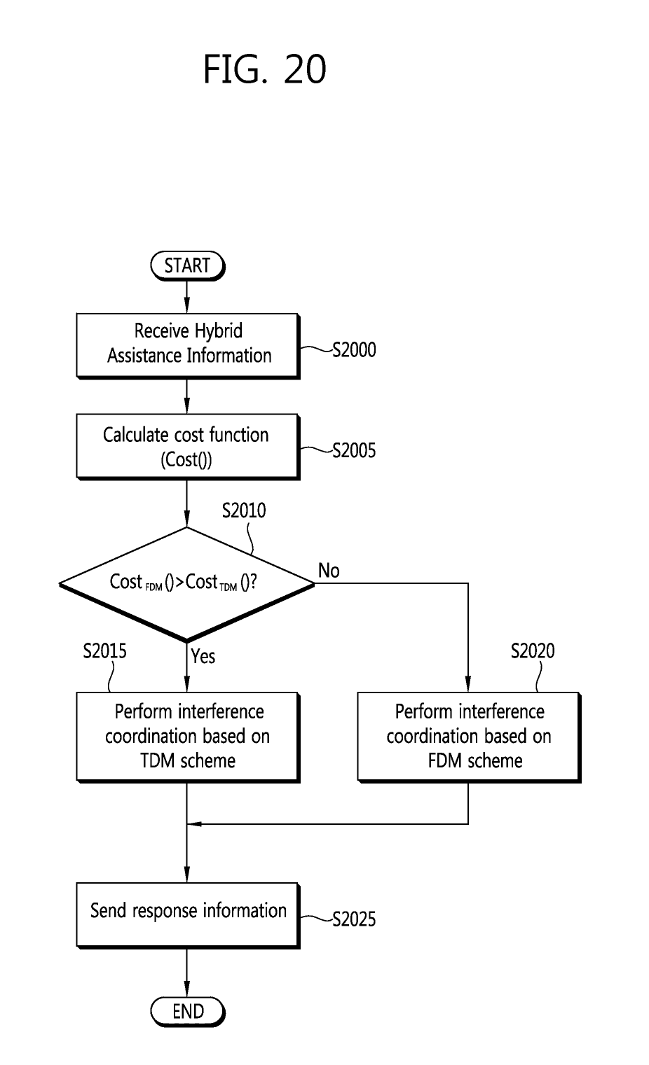

FIG. 20 is a flowchart illustrating a method of an eNB performing interference coordination in accordance with another example of the present invention. The method of performing interference coordination of FIG. 20 can be applied to each frequency band (or cell) in which interference is generated. Alternatively, the method of performing interference coordination of FIG. 20 can be applied to all the frequency bands (or cells) in which interference is generated at once. For example, assuming that cells configured in UE are a CC1, a CC2, and a CC3 and all the CC1, CC2, and CC3 experience IDC interference, interference coordination can be individually applied like CC1:FDM, CC2:TDM, and CC3: FDM or can be at once applied like CC1,CC2,CC3:FDM.

Referring to FIG. 20, the eNB receives HAI from UE at step S2000. The HAI includes the first assistance information and the second assistance information. The HAI can further include the identifier or the application indicator. The eNB calculates a cost function Cost( ) for each of the FDM scheme and the TDM scheme in order to determine that any one of the FDM scheme and the TDM scheme is disadvantageous for interference coordination at step S2005. A parameter for the cost function includes IDC interference and a load of a frequency band. For example, in the case of the FDM scheme, a value of the cost function will be great because interference is small, but a load of a frequency band is great. The TDM scheme is opposite to the FDM scheme. The meaning that a value of the cost function is great means that a corresponding interference coordination scheme is disadvantageous. In contrast, the meaning that a value of the cost function is small means that a corresponding interference coordination scheme is relatively advantageous.

The parameter for the cost function can include UE capabilities, such as a frequency Band Pass Filter (BPF) characteristic and a switch characteristic, a WiFi communication characteristic, a Bluetooth communication characteristic, and a GPS communication characteristic. The frequency BPF characteristic is an example of an index, indicating a case where it is difficult to implement the FDM scheme in a specific frequency band because performance in the specific frequency band is low depending on UE. Furthermore, the switch characteristic is an example of an index, indicating a case where it is difficult to implement the TDM scheme.

The eNB compares the cost function Cost_{FDM}( ) and the cost function Cost_{TDM}( ) according to the FDM and TDM schemes with each other at step S2010. If, as a result of the comparison, Cost_{FDM}( )>Cost_{TDM}( ), the eNB performs interference coordination based on the TDM scheme at step S2015. If Cost_{FDM}( )≦Cost_{TDM}( ), the eNB performs interference coordination based on the FDM scheme at step S2020. The eNB sends response information, including corresponding scheme information, to the UE at step S2025.

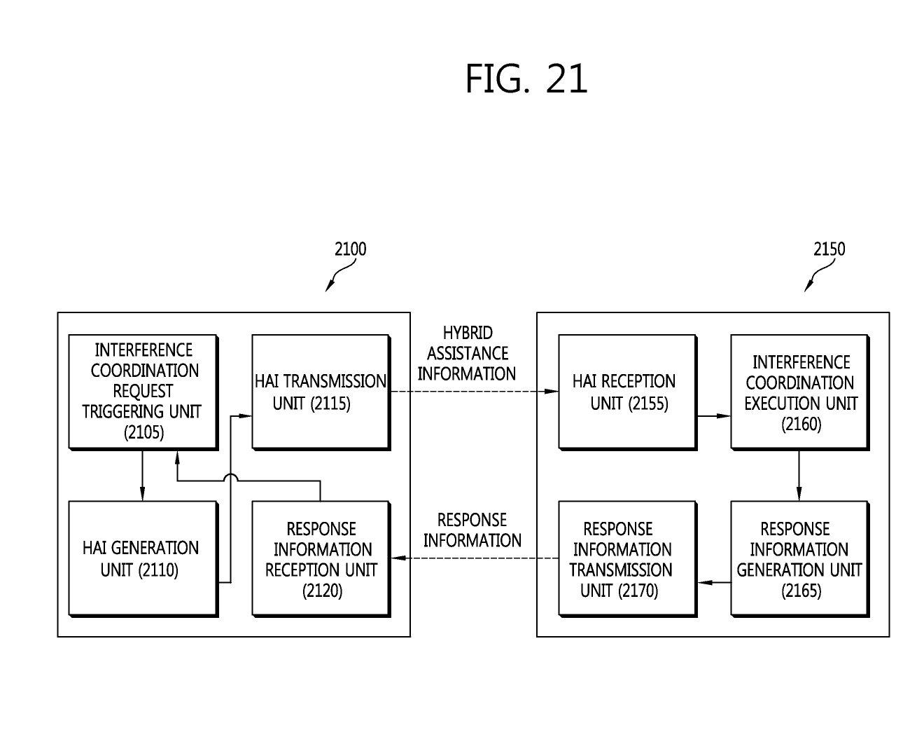

FIG. 21 is a block diagram of an apparatus for coordinating IDC interference in accordance with an example of the present invention.

Referring to FIG. 21, UE 2100 and an eNB 2150 exchange pieces of information about IDC interference. The pieces of information about IDC interference include response HAI transmitted by the UE 2100 and information transmitted by the eNB 2150.

The UE 2100 includes an interference coordination request triggering unit 2105, an HAI generation unit 2110, an HAI transmission unit 2115, and a response information reception unit 2120.

The interference coordination request triggering unit 2105 triggers an interference coordination request for IDC interference when the IDC interference is generated. The IDC interference can be generated in the following cases. For example, it is assumed that the UE 2100 sends a signal ‘y’ through another RF, such as WiFi, while receiving a signal ‘x’ from the eNB 2150 through an LTE RF. In this case, if the SINR of the signal ‘y’ becomes a specific threshold or higher and the signal ‘y’ functions as interference with the signal ‘x’, IDC interference is generated. The SINR has been illustrated as an example of a criterion in which interference is generated, but the present invention is not limited to the example. For example, RSRP or RSRQ can be used as the criterion.

When the interference coordination request is triggered, the HAI generation unit 2110 generates HAI. The HAI includes the first assistance information necessary for interference coordination based on the FDM scheme and the second assistance information necessary for interference coordination based on the TDM scheme. The second assistance information can also be called a TDM pattern.

The HAI generation unit 2110 can include a measurement result of the UE in the HAI. The HAI generation unit 2110 can further include at least one of a first result obtained by filtering measurement samples not including a measurement sample affected by the IDC interference, a second result including the IDC interference, and a difference value between the first result and the second result in the measurement result.

The HAI generation unit 2110 can further include at least one of the application indicator indicative of a frequency band or a cell to which the second assistance information is applied and the assistance information identifier for distinguishing the first assistance information and the second assistance information in the HAI. Here, the identifier can be a MAC message or physical layer signaling.

The HAI generation unit 2110 can include a usable band indicator indicative of a usable frequency band or an unusable band indicator indicative of an unusable frequency band in the first assistance information. Here, each of the usable band indicator and the unusable band indicator indicates a frequency band corresponding to a specific serving cell formed of at least one Component Carrier (CC). Furthermore, the avoidance indicator indicating that IDC interference based on the FDM scheme needs to be avoided can be included in the first assistance information.

The HAI generation unit 2110 can include information about the intensity of IDC interference regarding a frequency band, corresponding to a specific serving cell formed of at least one CC, in the first assistance information.

The HAI generation unit 2110 can include information about a time interval in which a first network system or a second network system is available or unavailable due to IDC interference in the second assistance information. The information about the time interval can be indicated in a bitmap form indicating that the time interval is an interference interval corresponding to one subframe. Alternatively, the information about the time interval can be indicated in such a way as to include at least one of a cycle of the time interval, a length of the time interval, information about an increment of the time interval, and a length of a DRX interval, which are determined by taking a scheduled interval for the UE into consideration.

The HAI transmission unit 2115 sends the HAI to the eNB 2150.

The eNB 2150 includes an HAI reception unit 2155, an interference coordination execution unit 2160, a response information generation unit 2165, and a response information transmission unit 2170.

The HAI reception unit 2155 receives HAI from the UE 2100.

The interference coordination execution unit 2160 can consider the HAI to be an interference coordination request from the UE 2100 and perform an assessment procedure on the request. The assessment procedure can be performed on each frequency band (or cell) in which interference is generated. Alternatively, the assessment procedure can be performed on all frequency bands (or cells) in which interference is generated.

First, the interference coordination execution unit 2160 determines that to use what interference coordination scheme is appropriate. For example, the interference coordination execution unit 2160 can assess an interference coordination scheme based on priority. That is, the interference coordination execution unit 2160 can first assess a possibility that a first interference coordination scheme can be applied to interference coordination and then assess a possibility that a second interference coordination scheme can be applied to interference coordination. For example, if whether or not the FDM scheme can be applied to interference coordination is first assessed and it is determined that the FDM scheme cannot be applied to interference coordination as a result of the determination, the interference coordination execution unit 2160 can determine whether or not the TDM scheme can be applied to interference coordination. Alternatively, the interference coordination execution unit 2160 may first assess whether or not the TDM scheme can be applied to interference coordination and then assess whether or not the FDM scheme can be applied to interference coordination.

For another example, the interference coordination execution unit 2160 can simultaneously assess the FDM scheme and the TDM scheme using the cost function. That is, the eNB can assess a possibility that the TDM scheme can be applied to interference coordination and a possibility that the FDM scheme can be applied to interference coordination at the same time or in parallel.

The interference coordination execution unit 2160 selects an interference coordination scheme determined to be appropriate based on the assessment and performs interference coordination based on the selected interference coordination scheme and corresponding assistance information. The interference coordination execution unit 2160 can apply the same interference coordination scheme to all the bands in which interference is generated at once or can apply a different interference coordination scheme to each band in which interference is generated. In some embodiments, the interference coordination execution unit 2160 can apply the same TDM scheme to all the bands in which interference is generated, but apply different TDM patterns to all the bands.

If both the interference coordination schemes are determined to be inappropriate as a result of the assessment, however, the interference coordination execution unit 2160 may not perform interference coordination. In this case, the interference coordination execution unit 2160 may perform no operation or induce the generation of response information indicating that interference coordination is rejected.

The response information generation unit 2165 generates response information, indicating that interference coordination is performed according to on any one of the FDM and TDM schemes selected based on the assessment, or response information, indicating that interference coordination is rejected if both the FDM scheme and the TDM scheme are determined to be inappropriate based on the assessment, based on a determination of the interference coordination execution unit 2160.

The response information indicative of the acceptance of the interference coordination request can have a different form depending on whether a scheme selected in the assessment procedure is the FDM or TDM scheme. For example, if the FDM scheme is selected, the response information indicating that the interference coordination request is accepted can be a cell reconfiguration message in a cell reconfiguration procedure, a handover command message in a handover procedure, a frequency shift indicator indicating that a band in which interference is generated needs to be shifted by a specific frequency offset, or a frequency shaping indicator indicating that some of a band in which interference is generated needs to be shaped.

For another example, if the TDM scheme is selected, response information indicating that the interference coordination request is accepted can be a DRX reconfiguration message in a DRX procedure, a DRX command message, or an ACK signal.

The response information transmission unit 2170 sends the response information to the UE 2100. Here, the response information transmission unit 2170 can send the response information through an RRC message, a MAC message, or physical layer signaling.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

1. A method of User Equipment (UE) coordinating interference in a wireless communication system, the method comprising:
performing triggering for requesting an eNB to coordinate interference generated in reception in a second frequency band of a second network system within the UE due to transmission in a first frequency band of a first network system within the UE;
sending Hybrid Assistance Information (HAI), comprising first assistance information that supports the eNB in coordinating the interference in a frequency domain based on a Frequency Division Multiplexing (FDM) scheme and second assistance information that supports the eNB in coordinating the interference in a time domain based on a Time Division Multiplexing (TDM) scheme, to the eNB; and
receiving response information indicative of an acceptance or rejection of the coordination of the interference from the eNB as a response to the HAI.

2. The method of claim 1, wherein:
the HAI comprises a measurement result of the UE, and
the measurement result further comprises at least one of a first result obtained by filtering measurement samples not comprising a measurement sample affected by In-Device Coexistence (IDC) interference, a second result comprising the IDC interference, and a difference value between the first result and the second result.

3. The method of claim 1, wherein the HAI further comprises at least one of an application indicator indicative of a frequency band or a cell to which the second assistance information is applied and an assistance information identifier for distinguishing the first assistance information and the second assistance information.

4. The method of claim 1, wherein:
the first assistance information comprises a usable band indicator indicative of a usable frequency band or an unusable band indicator indicative of an unusable frequency band,
each of the usable band indicator and the unusable band indicator indicates a frequency band corresponding to a specific serving cell formed of at least one Component Carrier (CC), and
the first assistance information comprises an avoidance indicator indicating that IDC interference based on the FDM scheme needs to be avoided.

5. The method of claim 1, wherein the first assistance information comprises an intensity of IDC interference regarding a frequency band corresponding to a specific serving cell formed of at least one CC.

6. The method of claim 1, wherein:
the second assistance information comprises information about a time interval unavailable or available for the first network system or the second network system due to the interference, and
the information about the time interval is indicated in a bitmap form indicating that the time interval is an interference interval in response to one subframe or is indicated in a form comprising at least one of a cycle of the time interval, a length of the time interval, information about an increment of the time interval, and a length of a discontinuous reception (DRX) interval which are determined by taking a scheduled interval for the UE into consideration.

7. The method of claim 1, wherein performing the triggering comprises:
a case where a Signal to Noise Interference Ratio (SINR) of the transmission in the first frequency band is a threshold or more, and
a case where IDC interference is detected using Reference Signal Received Power (RSRP) or Reference Signal Received Quality (RSRQ) in the first frequency band.

8. A User Equipment (UE) for coordinating interference in a wireless communication system, the UE comprising:
an interference coordination request triggering unit for performing triggering for requesting an eNB to coordinate interference generated in reception in a second frequency band of a second network system within the UE due to transmission in a first frequency band of a first network system within the UE;
a Hybrid Assistance Information (HAI) generation unit for generating HAI, comprising first assistance information that supports a coordination of the interference in a frequency domain based on a Frequency Division Multiplexing (FDM) scheme and second assistance information that supports the coordination of the interference in a time domain based on a Time Division Multiplexing (TDM) scheme;
an HAI transmission unit for sending the HAI; and
a response information reception unit for receiving response information indicative of an acceptance or rejection of the coordination of the interference from the eNB as a response to the HAI.

9. The UE of claim 8, wherein the HAI generation unit operates so that the HAI comprises a measurement result of the UE and the measurement result further comprises at least one of a first result obtained by filtering measurement samples not comprising a measurement sample affected by In-Device Coexistence (IDC) interference, a second result comprising the IDC interference, and a difference value between the first result and the second result.

10. The UE of claim 8, wherein the HAI generation unit operates so that the HAI further comprises at least one of an application indicator indicative of a frequency band or a cell to which the second assistance information is applied and an assistance information identifier for distinguishing the first assistance information and the second assistance information.

11. The UE of claim 8, wherein the HAI generation unit operates so that the first assistance information comprises a usable band indicator indicative of a usable frequency band or an unusable band indicator indicative of an unusable frequency band, each of the usable band indicator and the unusable band indicator indicates a frequency band corresponding to a specific serving cell formed of at least one Component Carrier (CC), and the first assistance information comprises an avoidance indicator indicating that IDC interference based on the FDM scheme needs to be avoided.

12. The UE of claim 8, wherein the HAI generation unit operates so that the first assistance information comprises an intensity of IDC interference regarding a frequency band corresponding to a specific serving cell formed of at least one CC.

13. The UE of claim 8, wherein the HAI generation unit operates so that the second assistance information comprises information about a time interval unavailable or available for the first network system or the second network system due to the interference, and the information about the time interval is indicated in a bitmap form indicating that the time interval is an interference interval in response to one subframe or is indicated in a form comprising at least one of a cycle of the time interval, a length of the time interval, information about an increment of the time interval, and a length of a discontinuous reception (DRX) interval which are determined by taking a scheduled interval for the UE into consideration.

14. The UE of claim 8, wherein the interference coordination request triggering unit performs the triggering when a Signal to Noise Interference Ratio (SINR) of the transmission in the first frequency band is a threshold or more and when IDC interference is detected using Reference Signal Received Power (RSRP) or Reference Signal Received Quality (RSRQ) in the first frequency band.

15. A method of an eNodeB (eNB) performing interference coordination in a wireless communication system, the method comprising:
receiving Hybrid Assistance Information (HAI), supporting a coordination of interference in a frequency domain based on a Frequency Division Multiplexing (FDM) scheme or supporting the coordination of the interference in a time domain based on a Time Division Multiplexing (TDM) scheme, from User Equipment (UE);
assessing a better scheme of the FDM scheme and the TDM scheme which is more suitable for coordinating the interference;
sending response information, indicating that the coordination of the interference is performed according to a scheme selected based on the assessment or that the coordination of the interference is rejected if both the FDM scheme and the TDM scheme are not suitable for coordinating the interference based on the assessment, to the UE,
wherein the interference is generated in reception in a second frequency band of a second network system within the UE due to transmission in a first frequency band of a first network system within the UE.

16. The method of claim 15, wherein in assessing a better scheme of the FDM scheme and the TDM scheme, priority is given to the FDM scheme over the TDM scheme.

17. The method of claim 15, wherein assessing a better scheme of the FDM scheme and the TDM scheme comprises:
comparing a first cost function according to the FDM scheme with a second cost function according to the TDM scheme, and
assessing a better scheme of the FDM scheme and the TDM scheme based on a result of the comparison.

18. The method of claim 15, wherein the response information comprises at least one of a cell reconfiguration message in a cell reconfiguration procedure, a handover command message in a handover procedure, a frequency shift indicator indicating that a band in which the interference is generated needs to be shifted by a specific frequency offset, and a frequency shaping indicator indicating that some of a band in which the interference is generated needs to be shaped.

19. The method of claim 15, wherein the response information comprises at least one of a discontinuous reception (DRX) reconfiguration message in a DRX procedure, a DRX command message, and acknowledgement (ACK).

20. An eNodeB (eNB) for performing interference coordination in a wireless communication system, the eNB comprising:
a Hybrid Assistance Information (HAI) reception unit for receiving HAI, supporting a coordination of interference in a frequency domain based on a Frequency Division Multiplexing (FDM) scheme or supporting the coordination of the interference in a time domain based on a Time Division Multiplexing (TDM) scheme, from User Equipment (UE);
an interference coordination execution unit for assessing a better scheme of the FDM scheme and the TDM scheme which is more suitable for coordinating the interference and performing the coordination of the interference according to any one of the FDM scheme and the TDM scheme selected based on the assessment;
a response information transmission unit for sending response information, indicating that the coordination of the interference is performed according to a scheme selected based on the assessment or that the coordination of the interference is rejected if both the FDM scheme and the TDM scheme are not suitable for coordinating the interference based on the assessment, to the UE,
wherein the interference is generated in reception in a second frequency band of a second network system within the UE due to transmission in a first frequency band of a first network system within the UE.
